(19) United States
(12) Patent Application Publication
(10) Pub. No.: US 2016/0155083 A1
(43) Pub. Date: Jun. 2, 2016

(54) DELIVERY MANAGEMENT SYSTEM, IMAGE FORMING APPARATUS, IMAGE ACQUISITION APPARATUS, DELIVERY MANAGEMENT APPARATUS, NON-TRANSITORY COMPUTER READABLE MEDIUM, AND DELIVERY MANAGEMENT METHOD

(71) Applicant: FUJI XEROX CO., LTD., Tokyo (JP)

(72) Inventors: Takeshi TAKEI, Kanagawa (JP); Tsubasa NISHINO, Kanagawa (JP)

(73) Assignee: FUJI XEROX CO., LTD., Tokyo (JP)

(21) Appl. No.: 14/713,596

(22) Filed: May 15, 2015

(30) Foreign Application Priority Data
Nov. 28, 2014 (JP) 2014-242328

(51) Int. Cl. G06Q 10/08; G06K 19/06; G06Q 30/00

(52) U.S. Cl. CPC G06Q 10/0833; G06Q 30/016; G06K 19/06028

(57) ABSTRACT

A delivery management system includes a first image acquisition unit, a delivery information acquisition unit, an identification information acquisition unit, and a memory. The first image acquisition unit acquires, at an origin, an image of a delivery item to be delivered to a destination. The delivery information acquisition unit acquires delivery information regarding the delivery item. The identification information acquisition unit acquires identification information that identifies the delivery item. The memory stores the image of the delivery item, the delivery information regarding the delivery item, and the identification information of the delivery item in association with one another.

### CROSS-REFERENCE TO RELATED APPLICATIONS

This application is based on and claims priority under 35 USC 119 from Japanese Patent Application No. 2014-242328 filed Nov. 28, 2014.

### BACKGROUND

(i) Technical Field

The present invention relates to a delivery management system, an image forming apparatus, an image acquisition apparatus, a delivery management apparatus, a non-transitory computer readable medium, and a delivery management method.

(ii) Related Art

A user is able to check a delivery status of a delivery item, for example, by accessing a server apparatus that stores the delivery status. For example, the delivery status output from the server apparatus is sent to a terminal apparatus, such as a personal computer (PC), and is displayed as text information on the terminal apparatus.

### SUMMARY

According to an aspect of the invention, there is provided a delivery management system including a first image acquisition unit, a delivery information acquisition unit, an identification information acquisition unit, and a memory. The first image acquisition unit acquires, at an origin, an image of a delivery item to be delivered to a destination. The delivery information acquisition unit acquires delivery information regarding the delivery item. The identification information acquisition unit acquires identification information that identifies the delivery item. The memory stores the image of the delivery item, the delivery information regarding the delivery item, and the identification information of the delivery item in association with one another.

### BRIEF DESCRIPTION OF THE DRAWINGS

Exemplary embodiments of the present invention will be described in detail based on the following figures, wherein:

FIG. 1 illustrates an overall configuration of a delivery management system according to an exemplary embodiment;

FIG. 2 is a functional block diagram of an image acquisition apparatus;

FIG. 3 is a functional block diagram of a server apparatus which is an example of a delivery management apparatus;

FIG. 4 is a functional block diagram of an image acquisition apparatus;

FIG. 5 illustrates an example of a delivery item;

FIG. 6 describes a sending operation performed by a sender at each division of a branch;

FIG. 7 describes a sending operation performed by a sender at each division of a branch;

FIGS. 8A and 8B each describe a sending operation performed by a sender at each division of a branch;

FIG. 9 describes a sending operation performed by a sender at each division of a branch;

FIG. 10 describes a sending operation performed by a sender at each division of a branch;

FIG. 11 describes a sending operation performed by a sender at each division of a branch;

FIG. 12 illustrates a delivery route table;

FIG. 13 illustrates a mail inbox;

FIG. 14 illustrates an exemplary window displayed on an operation screen;

FIG. 15 illustrates a list of information sets stored in a storage unit of the server apparatus;

FIGS. 16A and 16B each illustrate a search window displayed at the time of a search;

FIG. 17 illustrates a result of a search by a sender;

FIGS. 18A and 18B each illustrate a result of a search by a sender;

FIG. 19 illustrates a result of a search by an administrator;

FIG. 20 illustrates a result of a search by an administrator;

FIG. 21 illustrates an example of a configuration of the delivery management system according to an exemplary embodiment used for in-house round robin decision making;

FIG. 22 illustrates an exemplary window displayed on the operation screen; and

FIG. 23 illustrates an exemplary window displayed on the operation screen.

### DETAILED DESCRIPTION

Exemplary embodiments of the present invention will be described in detail below with reference to the accompanying drawings.

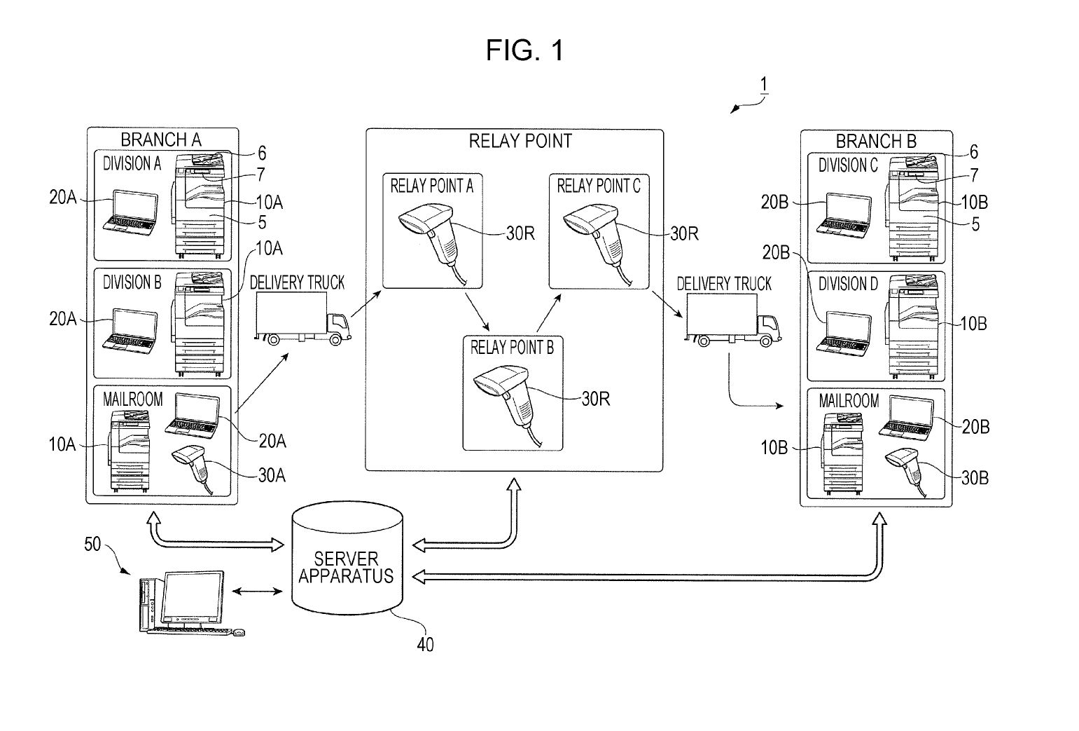

FIG. 1 illustrates an overall configuration of a delivery management system 1 according to an exemplary embodiment. Note that a case of delivering a delivery item from a branch A to a branch B within a company will be described below by way of example.

In the delivery management system 1 according to the exemplary embodiment, multiple image acquisition apparatuses 10A are installed at the branch A. The branch A has multiple divisions, such as divisions A and B. The image acquisition apparatuses 10A are installed at the respective divisions A and B. Terminal apparatuses 20A, such as personal computers (PCs), are also installed at the respective divisions A and B.

In addition, the branch A has a mailroom where delivery items are processed. The mailroom is equipped with a barcode reader 30A that reads a barcode attached to each delivery item. The mailroom is also equipped with the image acquisition apparatus 10A that acquires an image of a delivery item and the terminal apparatus 20A, such as a PC.

Likewise, multiple image acquisition apparatuses 10B are installed at the branch B. The branch B also has multiple divisions, such as divisions C and D. The image acquisition apparatuses 10B and terminal apparatuses 20B are installed at the respective divisions C and D. In addition, the branch B also has a mailroom where delivery items are processed. The mailroom is equipped with the image acquisition apparatus 10B, the terminal apparatus 20B, and a barcode reader 30B.

The image acquisition apparatuses 10A and 10B are, for example, multifunction image forming apparatuses and have multiple functions. The image acquisition apparatuses 10A and 10B each include an image forming unit 5 that forms an image on a sheet. The image acquisition apparatuses 10A and 10B each include an image acquisition unit (scanning unit) 6 that acquires an image formed on a sheet.

In the exemplary embodiment, an image of a delivery item is acquired by using the image acquisition unit 6. The image acquisition apparatuses 10A and 10B each further include a fax function for sending and receiving a fax.

In addition, the image acquisition apparatuses 10A and 10B each include an operation screen (input screen) 7 operated by a sender or recipient of a delivery item. The operation screen 7 is, for example, a touch panel.

The image acquisition apparatuses 10A and 10B each include the image forming unit 5 that forms an image and thus are considered as image forming apparatuses.

In the delivery management system 1, relay points for a delivery item are provided between the branch A and the branch B. In the exemplary embodiment, three relay points, namely, relay points A, B, and C, are provided. At each of the relay points A, B, and C, a barcode reader 30R that reads a barcode attached to a delivery item is installed.

The delivery management system 1 further includes a server apparatus 40 which is an example of a delivery management apparatus. The server apparatus 40 is connected to the image acquisition apparatuses 10A, the terminal apparatuses 20A, and the barcode reader 30A that are installed at the branch A; the image acquisition apparatuses 10B, the terminal apparatuses 20B, and the barcode reader 30B that are installed at the branch B; and the barcode readers 30R installed at the relay points A, B, and C.

The delivery management system 1 further includes a management terminal 50, such as a PC. The management terminal 50 is also connected to the server apparatus 40.

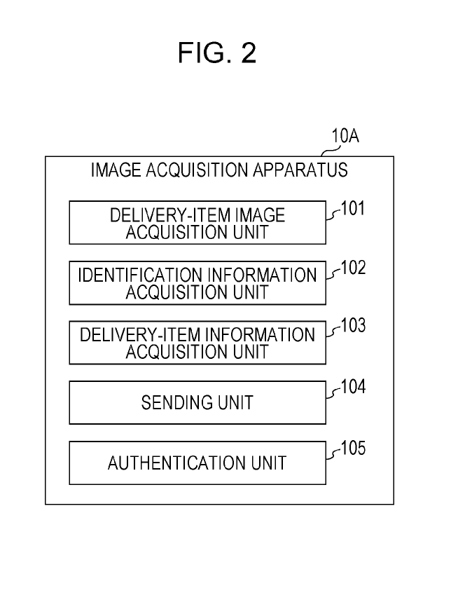

FIG. 2 is a functional block diagram of the image acquisition apparatus 10A.

The image acquisition apparatus 10A includes a delivery-item image acquisition unit 101, an identification information acquisition unit 102, a delivery-item information acquisition unit 103, a sending unit 104, and an authentication unit 105.

The delivery-item image acquisition unit 101, which is an example of a first image acquisition unit, is realized by the image acquisition unit (scanning unit) 6 (see FIG. 1). The delivery-item image acquisition unit 101 scans a delivery item and acquires an image (hereinafter, referred to as a “delivery-item image”) of the delivery item to be delivered to a destination.

The identification information acquisition unit 102 is realized by a central processing unit (CPU) controlled based on a program. The identification information acquisition unit 102 analyzes an image of a barcode acquired by the image acquisition unit 6, namely, a barcode image included in a delivery-item image (described in detail later) and acquires identification information (hereinafter, referred to as “delivery-item identification information”) that identifies the delivery item.

The delivery-item information acquisition unit 103 is realized by the CPU controlled based on a program. The delivery-item information acquisition unit 103 analyzes a delivery-item image acquired by the image acquisition unit 6 and acquires information assigned to the delivery item.

The sending unit 104 is implemented by a communication interface, for example. The sending unit 104 sends information, such as a delivery-item image, to the server apparatus 40 (see FIG. 1) that functions as a storage device.

The authentication unit 105 is implemented by the CPU controlled based on a program. The authentication unit 105 performs authentication of an operator who operates the image acquisition apparatus 10A, that is, determines whether the operator is an authorized operator, by comparing information obtained from the operator with information concerning operators pre-stored in the image acquisition apparatus 10A.

The exemplary embodiment describes an exemplary case where authentication of the operator (sender) is performed by the image acquisition apparatus 10A; however, information obtained from the operator may be sent to an authentication server that pre-sores information concerning operators, and authentication may be performed by this authentication server.

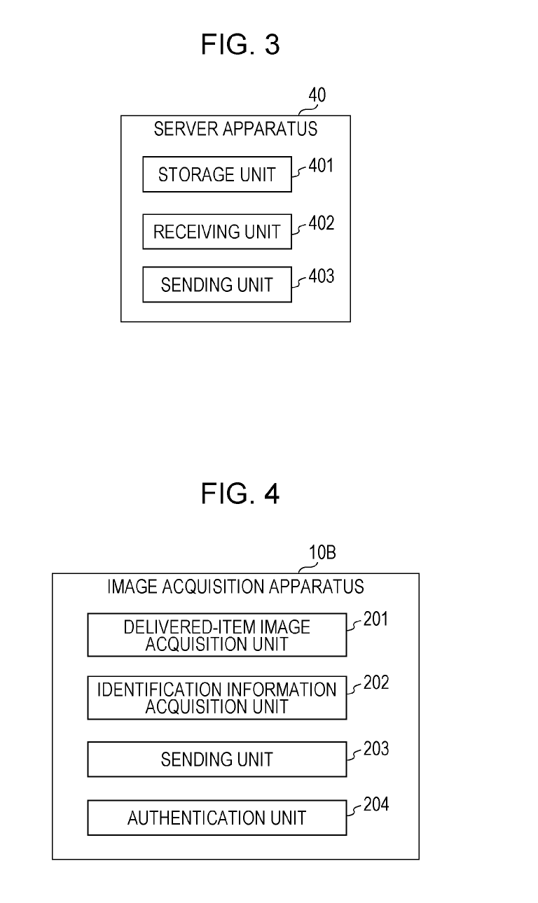

FIG. 3 is a functional block diagram of the server apparatus 40, which is an example of a delivery management apparatus.

The server apparatus 40 includes a storage unit 401. The storage unit 401 is realized by a hard disk drive, for example, and stores information, such as a delivery-item image, delivery information (delivery status), and delivery-item identification information in association with one another.

The server apparatus 40 further includes a receiving unit 402 and a sending unit 403. The receiving unit 402 receives information, such as a delivery-item image, delivery information (delivery status), and delivery-item identification information that are sent from the branches A and B and the relay points A, B, and C. The sending unit 403 sends information to the branches A and B and the relay points A, B, and C. The receiving unit 402 and the sending unit 403 are realized by a communication interface, for example.

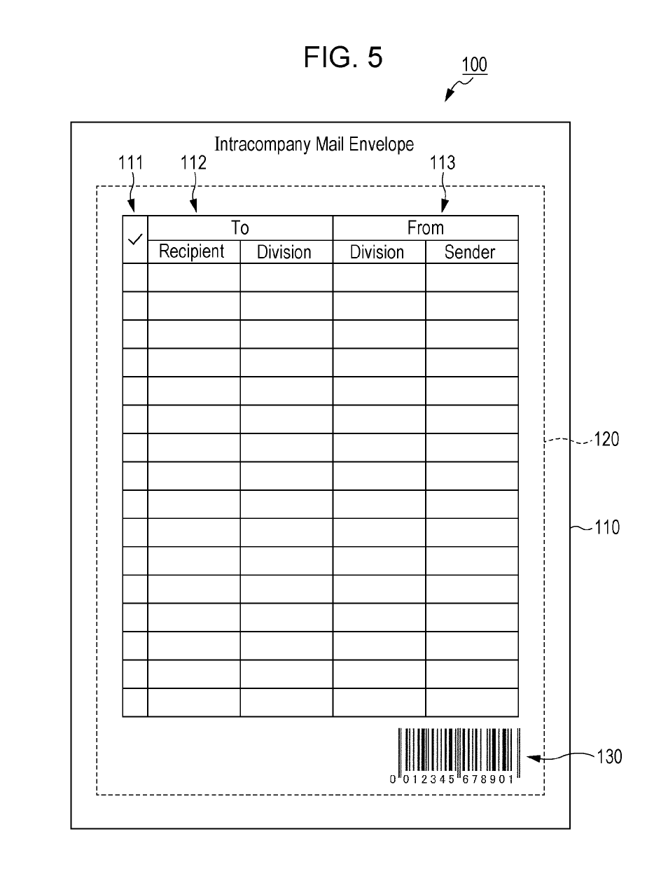

FIG. 4 is a functional block diagram of the image acquisition apparatus 10B.

The image acquisition apparatus 10B includes a delivered-item image acquisition unit 201, an identification information acquisition unit 202, a sending unit 203, and an authentication unit 204.

The delivered-item image acquisition unit 201 is realized by the image acquisition unit 6. The delivered-item image acquisition unit 201 scans a delivery item that has been delivered to a destination and acquires an image of the delivered item (hereinafter, referred to as a “delivered-item image”).

The identification information acquisition unit 202 is realized by a CPU controlled based on a program. The identification information acquisition unit 202 analyzes an image of a barcode acquired by the image acquisition unit 6, namely, a barcode image included in a delivered-item image, and acquires delivery-item identification information attached to the delivered item.

The sending unit 203 is realized by a communication interface, for example. The sending unit 203 sends information regarding a recipient of a delivery item, a delivered-item image, and delivery-item identification information to the server apparatus 40 which functions as a storage device.

The authentication unit 204 is realized by the CPU controlled based on a program. The authentication unit 204 performs authentication of an operator who operates the image acquisition apparatus 10B by comparing information obtained from the operator with information concerning operators pre-stored in the image acquisition apparatus 10B.

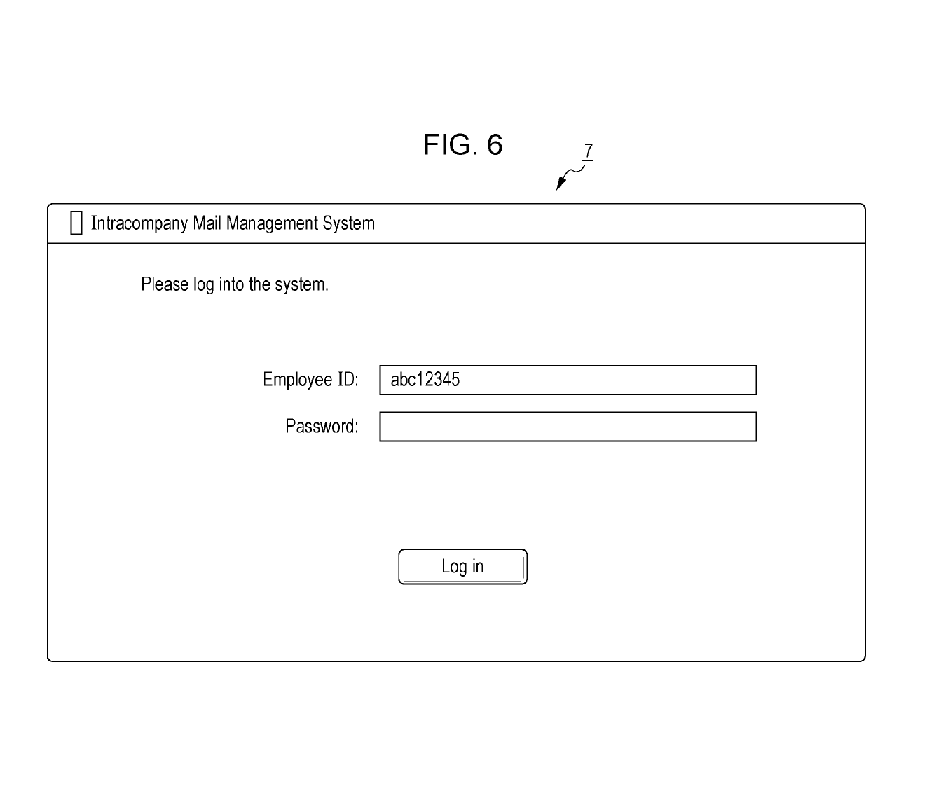

FIG. 5 illustrates an example of a delivery item.

A delivery item 100 used in the exemplary embodiment is composed of a delivery envelope 110 and a content 120 of the delivery envelope 110. On the delivery envelope 110, a barcode 130, which is an example of a code image containing delivery-item identification information used to identify the delivery item 100, is printed in advance.

A check field 111, a destination (“To”) field 112, and an origin (“From”) field 113 are also printed on the delivery envelope 110. A sender of the delivery item 100 checks the topmost blank box of the check field 111. The sender also fills the destination field 112 with the name of a recipient who receives the delivery item 100 and the name of a division to which the recipient belongs. The sender further fills the origin field 113 with his/her name and the name of a division to which the sender belongs.

### Process at Each Division of Branch A

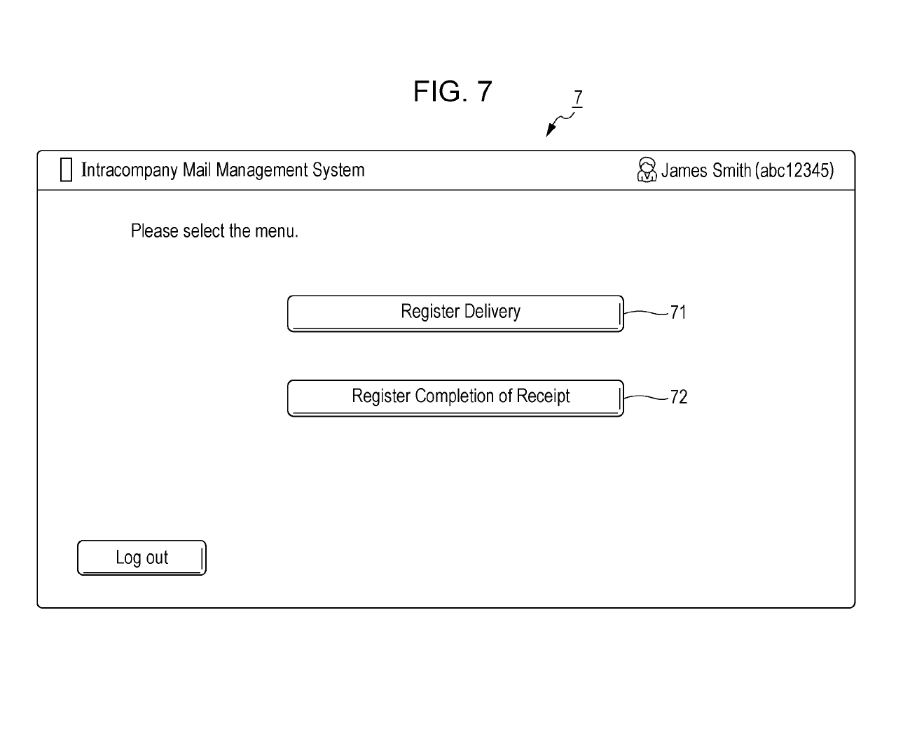

FIGS. 6 to 11 describe a sending operation performed by a sender at each division of the branch A.

When a sender sends the delivery item 100, the sender operates the image acquisition apparatus 10A installed at the division to which the sender belongs, namely, the division A or B. At that time, an authentication process is performed first in the exemplary embodiment.

Specifically, upon the sender starting operating the image acquisition apparatus 10A, the authentication unit 105 displays a login window on the operation screen 7 as illustrated in FIG. 6. That is, the authentication unit 105 displays a window for authentication of the sender. The sender inputs his/her employee ID and password on this window.

The authentication unit 105 compares the input set of the employee ID and the password with sets of the employee ID and the password pre-stored in the image acquisition apparatus 10A. If the set of the employee ID and the password input by the sender matches one of the sets of the employee ID and the password pre-stored in the image acquisition apparatus 10A, that is, if authentication is successful, the authentication unit 105 switches the window displayed on the operation screen 7 to another window.

The case of performing an authentication process by prompting the sender to input his/her employee ID and password has been described above by way of example; however, the authentication process may be performed by reading an ID card prepared for each employee.

After the authentication has been finished, the login window displayed on the operation screen 7 is switched to another window (not illustrated) which includes multiple icons (images for selecting functions). For example, an icon to be pressed (selected) by the operator to start copying and an icon to be pressed by the operator to start a scan are displayed. Further, an icon (icon for delivery) to be pressed by a sender to send the delivery item 100 or by a recipient to receive the delivery item 100 is displayed.

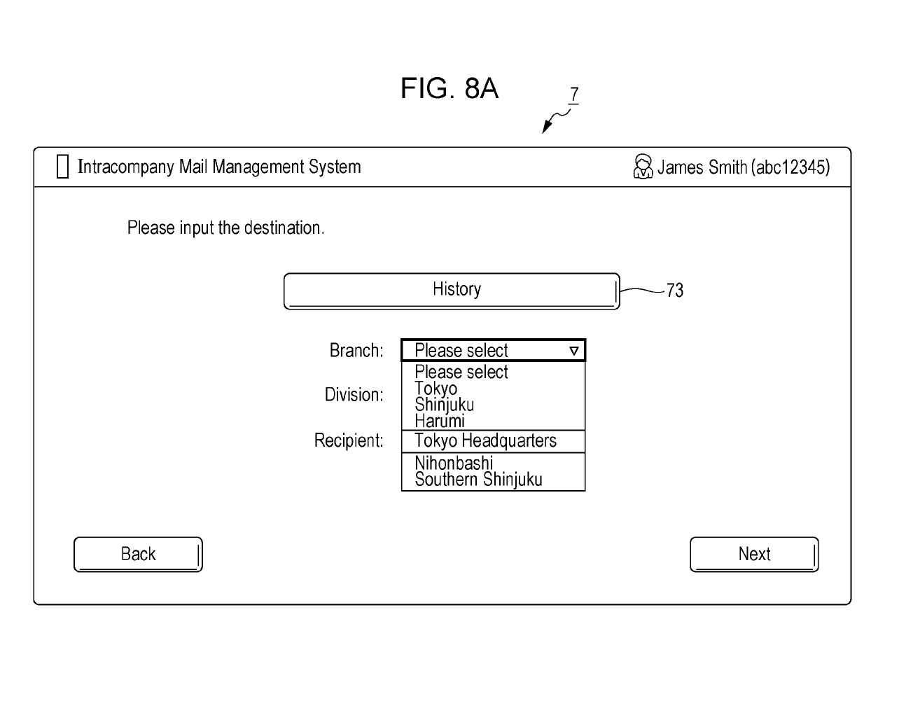

FIG. 7 illustrates the operation screen 7 after the icon for delivery is pressed.

In response to pressing of the icon for delivery, a “Register Delivery” button 71 and a “Register Completion of Receipt” button 72 are displayed as illustrated in FIG. 7. This step is a step of sending the delivery item 100, and thus the sender presses the “Register Delivery” button 71.

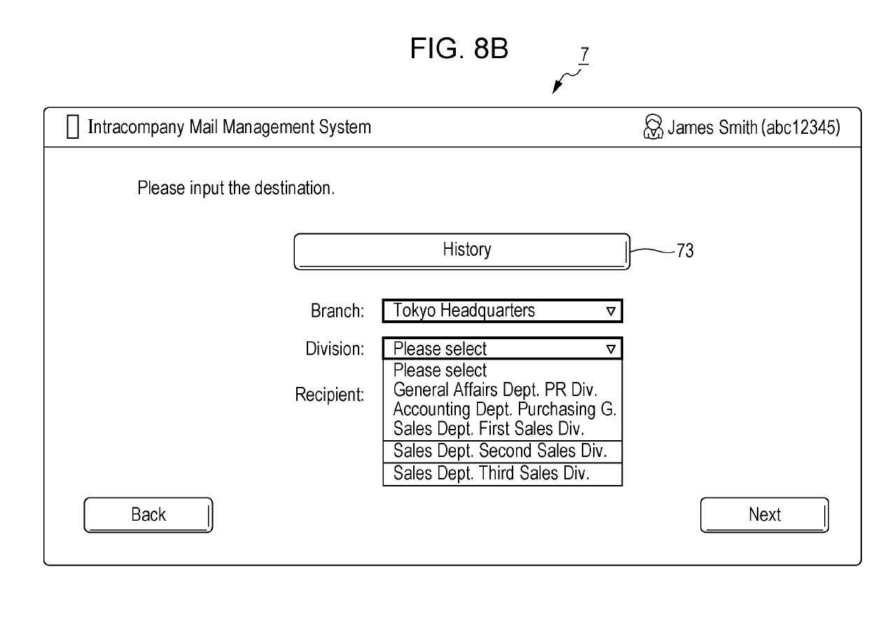

In response to pressing of the “Register Delivery” button 71, a destination input window is displayed as illustrated in FIG. 8A. On the destination input window, the sender inputs (selects) the name of a branch as illustrated in FIG. 8A. The sender then inputs (selects) the name of a division as illustrated in FIG. 8B. The sender lastly inputs (selects) the name of the recipient (not illustrated).

As described above, the image acquisition apparatus 10A according to the exemplary embodiment is provided with the operation screen 7 operated by the sender. The destination to which the delivery item 100 is to be delivered is input on the operation screen 7.

That is, in the exemplary embodiment, a window for accepting the destination of the delivery item 100 from the sender is displayed on the operation screen 7. The sender then performs an operation on the operation screen 7 to input the destination.

The destination may be input by operating the image acquisition apparatus 10A in this manner. The destination may also be input by a person in charge at the mailroom by using the terminal apparatus 20A. Specifically, the destination may be input as a result of a person in charge at the mailroom inputting the handwritten destination on the delivery envelope 110 by using the terminal apparatus 20A.

Even in the case where the destination has been input using the image acquisition apparatus 10A and has been registered in the server apparatus 40, a person in charge at the mailroom may correct the destination by using the terminal apparatus 20A installed at the mailroom upon finding out the destination that has been registered in the server apparatus 40 being incorrect.

The destination may be directly input through the operation screen 7, instead of selecting the destination in the above-described manner. In such a case, it may be verified whether the input destination exists by using a database (not illustrated). More specifically, a database storing a list of destinations is prepared. The input destination is compared with the destinations stored in the database. In this way, it may be determined whether the input destination exists.

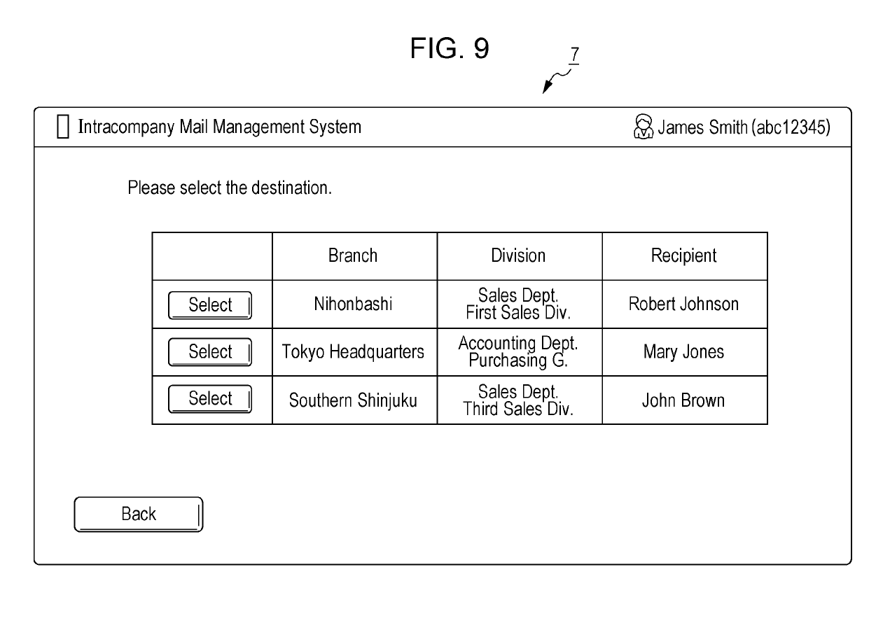

When a user (sender) selects a “History” button 73 illustrated in FIG. 8A, a list of destinations to which the sender has sent a delivery item is displayed as illustrated in FIG. 9. In the exemplary embodiment, the destination may be input by selecting the destination from this list.

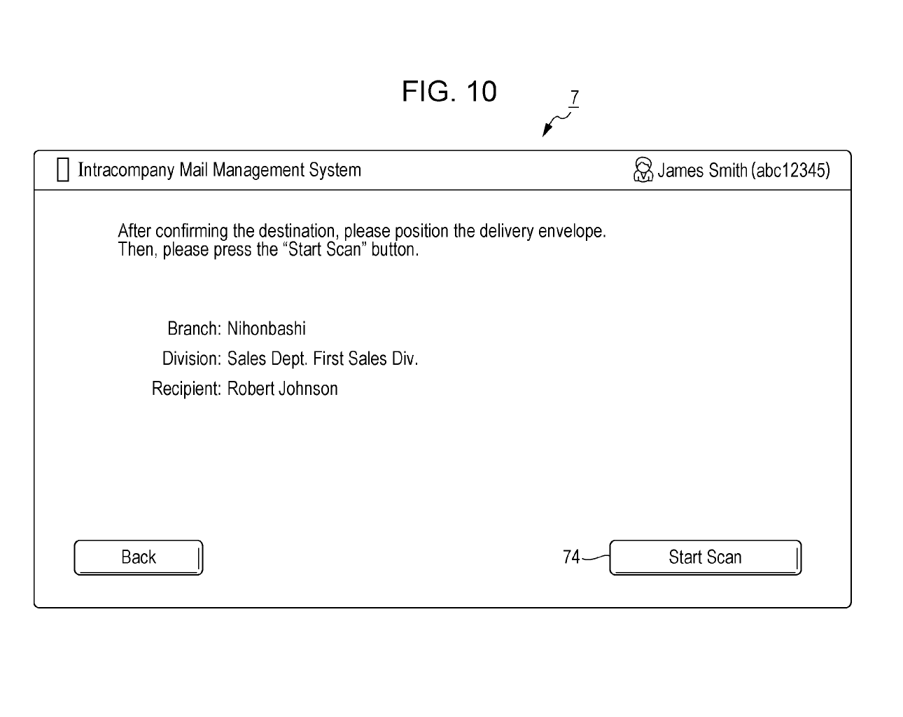

After inputting of the destination has been finished, a window illustrated in FIG. 10 is displayed on the operation screen 7. This window displays a message prompting confirmation of the destination and displays the name of the branch, the name of the division, and the name of the recipient that have been input by the sender. The window also displays a “Start Scan” button 74 at the lower right portion.

The sender positions the delivery item 100 at the image acquisition unit 6 and then presses the “Start Scan” button 74 illustrated in FIG. 10. This action causes the image acquisition apparatus 10A to acquire a delivery-item image, which is an image of the delivery item 100. The maximum size of an item which the image acquisition unit 6 is able to scan is larger than the size of the delivery item 100 illustrated FIG. 5. Accordingly, an image of the entire delivery item 100 is acquired in the exemplary embodiment.

The identification information acquisition unit 102 of the image acquisition apparatus 10A then analyzes an image of the barcode 130 (code image) included in the delivery-item image and acquires delivery-item identification information contained in the code image.

The sending unit 104 then sends both the delivery-item image and the delivery-item identification information to a medium that is viewable at the origin or a medium that manages the delivery status. More specifically, in the exemplary embodiment, the sending unit 104 sends the delivery-item image and the delivery-item identification information to the server apparatus 40.

The sending unit 104 also sends information regarding the destination (i.e., the name of the branch, the name of the division, and the name of the recipient) input by the sender to the server apparatus 40 along with the delivery-item image and the delivery-item identification information. The sending unit 104 also sends, to the server apparatus 40, sender information which is information regarding the sender.

The sending unit 104 further sends, to the server apparatus 40, apparatus identification information that identifies each of the image acquisition apparatuses 10A, such as the serial number assigned to the image acquisition apparatus 10A. The sending unit 104 also sends, to the server apparatus 40, as the sent date and time of the delivery item 100, the date and time at which the image of the delivery item 100 (delivery-item image) has been acquired, for example.

The storage unit 401 of the server apparatus 40 stores, in association with one another, the delivery-item image, the delivery-item identification information, the information regarding the destination, the sender information, the apparatus identification information, and the sent date and time that have been sent from the image acquisition apparatus 10A.

In the exemplary embodiment, the employee ID (specifically “abc12345”) input on the window illustrated in FIG. 6 is sent as the sender information from the image acquisition apparatus 10A to the server apparatus 40. That is, information regarding the sender who has been authenticated by the authentication unit 105 is sent as the sender information to the server apparatus 40. This configuration may prevent spoofing of the sender. Specifically, a situation may be prevented in which a person not sending the delivery item 100 is registered as the sender in the server apparatus 40.

The case of displaying the destination input window and prompting the sender to input the destination through the window as illustrated in FIGS. 8A and 8B has been described above by way of example; however, the destination input window may be provided with a “Next” button (not illustrated), and the window may be switched to another one even if the destination has not been input (by skipping inputting of the destination).

In such a case, a person in charge at the mailroom inputs destination information written on the delivery envelope 110 by using the terminal apparatus 20A at the mailroom to register the destination in the server apparatus 40.

In addition, a process may also be performed such that the destination input window is not displayed on the image acquisition apparatus 10A and the destination is input at the mailroom.

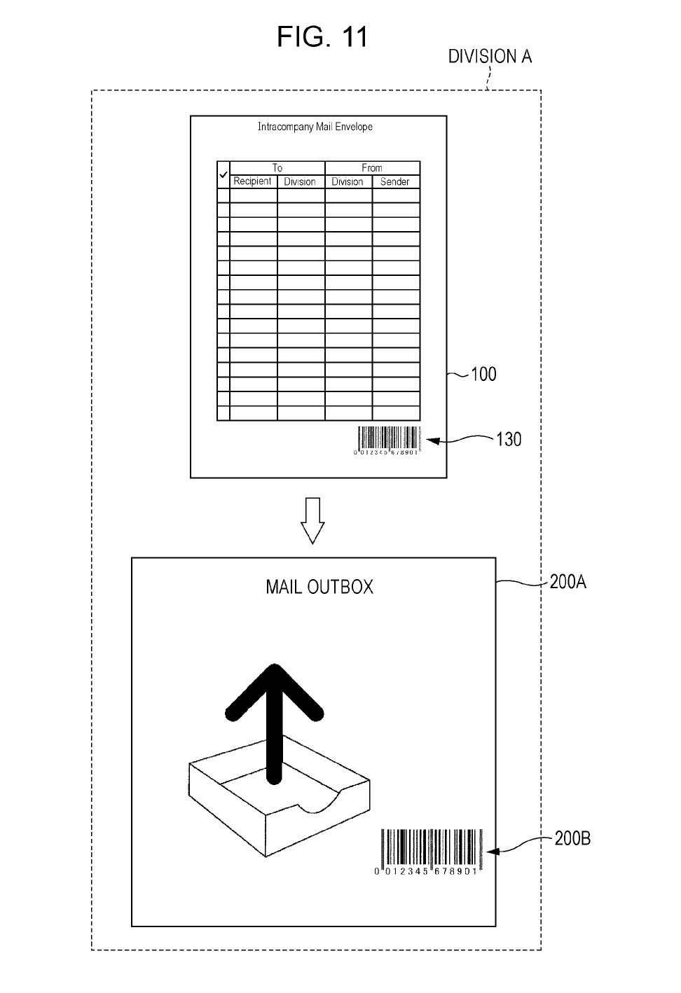

FIG. 11 illustrates a mail outbox 200A installed at each of the divisions, for example, the division A, of the branch A.

In the delivery management system 1 according to the exemplary embodiment, the mail outbox 200A illustrated in FIG. 11 is installed at each division. The sender performs a registration process by using the image acquisition apparatus 10A installed at the division to which the sender belongs in a manner described above. After the sender has completed the registration process, the sender puts the delivery item 100 in the mail outbox 200A installed at the division to which the sender belongs.

The delivery items 100 of other senders are also put in the mail outbox 200A. That is, the mail outbox 200A contains multiple delivery items 100.

The mail outbox 200A is attached with a barcode (code image) 200B. The barcode 200B contains identification information that identifies the mail outbox 200A (hereinafter, referred to as “outbox identification information”).

### Process Performed at Mailroom of Branch A

The mail outboxes 200A installed at the respective divisions of the branch A are collected at the mailroom (see FIG. 1) of the branch A. At the mailroom, the barcode 200B attached to each mail outbox 200A is read by the barcode reader 30A. In this way, the outbox identification information assigned to each mail outbox 200A is acquired.

Further, the barcode 130 (see FIG. 5) attached to each of the delivery items 100 contained in each mail outbox 200A is read by the barcode reader 30A. In this way, delivery-item identification information assigned to each delivery item 100 is also acquired.

In the exemplary embodiment, the outbox identification information and the delivery-item identification information are sent from the mailroom to the server apparatus 40 in association with each other. Further, information such as the received date and time of the delivery item 100 at the mailroom is also sent from the mailroom to the server apparatus 40. In the exemplary embodiment, the date and time at which the barcode 130 has been read by the barcode reader 30A is handled as the received date and time of the delivery item 100 at the mailroom.

The storage unit 401 of the server apparatus 40 associates, by using the delivery-item identification information as the key, information such as the outbox identification information and the received date and time with already registered information associated with the delivery-item identification information.

This association allows the sender to grasp that the delivery item 100 has been moved to the mailroom by accessing the server apparatus 40 using the terminal apparatus 20A installed at the division or a PC owned by the sender.

In the exemplary embodiment, the outbox identification information is registered. This configuration makes it easier to identify the sender when the sender of the delivery item 100 is unknown.

A case is assumed where the delivery item 100 is put in the mail outbox 200A without the registration process at the image acquisition apparatus 10A and no information is written in the destination field 112 and the origin field 113 of the delivery envelope 110 (see FIG. 5).

Even in such a case, if the outbox identification information of the mail outbox 200A is known, that is, if the outbox identification information is registered in the server apparatus 40, the outbox identification information allows the division from which the delivery item 100 has been sent to be grasped. Consequently, the sender is narrowed down to people belonging to the division.

The sender is narrowed down by using the outbox identification information in this example; however, the sender may be narrowed down by using the apparatus identification information that identifies the image acquisition apparatus 10A.

If the apparatus identification information is known, the apparatus identification information enables the image acquisition apparatus 10A used by the sender to be identified. Consequently, the sender is narrowed down to people belonging to the division where this image acquisition apparatus 10A is installed.

There may be a case where the delivery item 100 is not put in the mail outbox 200A, for example, because the sender has forgotten to do so regardless of information such as the delivery-item image and the sender information has been registered in the server apparatus 40. In such a case, the number of delivery items 100 that have been registered disagree with the number of delivery items 100 whose barcode 130 is read at the mailroom. In this way, the delivery item 100 that has been forgotten to be put in is detectable at the mailroom. In addition, in this case, the sender who has forgotten to put in the delivery item 100 is identifiable by referring to the server apparatus 40.

### Process Performed at Relay Point

As illustrated in FIG. 1, three relay points, namely, the relay points A, B, and C, are provided in the exemplary embodiment. Each of the relay points A, B, and C is provided with the barcode reader 30R which functions as part of the delivery information acquisition unit that acquires the delivery information (delivery status) regarding the delivery item 100.

The barcode reader 30R reads the barcode 130 attached to the delivery item 100 and acquires the delivery-item identification information.

In response to arrival of the delivery item 100 at each of the relay points A, B, and C, the barcode reader 30R reads the barcode 130 and acquires the delivery-item identification information. In addition, the date and time at which the barcode 130 has been read is handled as the arrival date and time of the delivery item 100 at the relay point. Further, before the delivery item 100 is sent to the following relay point, the barcode 130 is read again, and the delivery-item identification information is acquired. The date and time at which the barcode 130 has been read is handled as the sent date and time.

The delivery-item identification information, the arrival date and time, and the sent date and time that are acquired at each relay point are sent to and registered in the server apparatus 40. Identification information that identifies each barcode reader 30R is also sent to the server apparatus 40. Based on this identification information, the server apparatus 40 grasps the relay point which the delivery item 100 has arrived at. The server apparatus 40 stores, in association with each other, the identification information that identifies each barcode reader 30R and the relay point where the barcode reader 30R is installed.

The server apparatus 40 associates, by using the delivery-item identification information that has been sent thereto as the key, the arrival date and time, the sent date and time, and the relay point with already registered information associated with the delivery-item identification information.

In the exemplary embodiment, delivery information regarding the delivery item 100 is registered in the server apparatus 40 in this manner. Here, the term “delivery information” refers to information containing time information regarding the delivery item 100 and location information which indicates the location of the delivery item 100. Specifically, the delivery information is, for example, information containing location information indicating the location of the delivery item 100, information regarding the time at which the delivery item 100 has arrived at a predetermined location, and information regarding the time at which the delivery item 100 has been sent from a predetermined location.

In this exemplary embodiment, the relay points are automatically decided upon in response to the sender registering the destination at the branch A although a description thereof is omitted above.

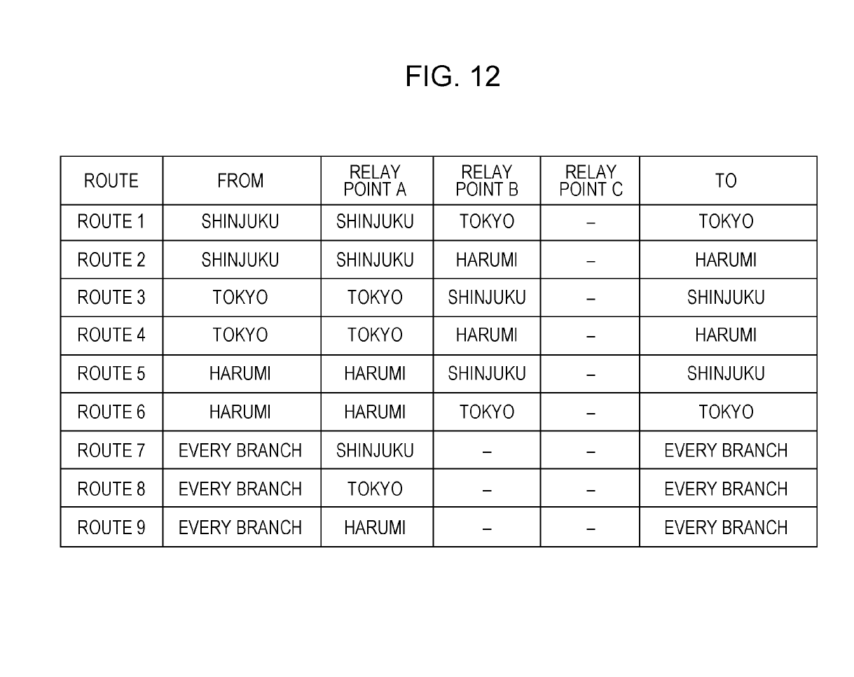

Specifically, the server apparatus 40 stores a delivery route table, such as the one illustrated in FIG. 12, which illustrates a delivery route table. Once the destination information and the apparatus identification information are sent from the image acquisition apparatus 10A installed at the branch A to the server apparatus 40, the server apparatus 40 grasps the branch where the image acquisition apparatus 10A is installed by using the apparatus identification information. The server apparatus 40 then decides upon the relay points by referring to the delivery route table using the identified branch and the destination information obtained from the image acquisition apparatus 10A.

### Process Performed at Mailroom of Branch B

In response to arrival of the delivery items 100 at the branch B (see FIG. 1), the delivery items 100 are sent to the mailroom. At the mailroom, the delivery items 100 are sorted.

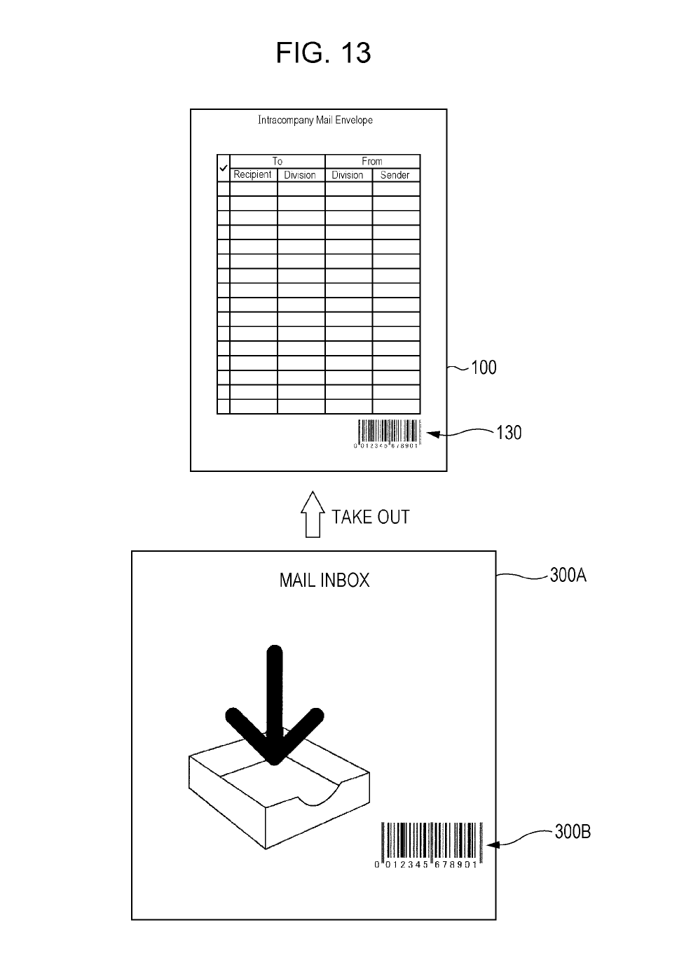

Specifically, the branch B has multiple divisions, such as the divisions C and D. A sorting process is performed at the mailroom so that the delivery items 100 are delivered to the corresponding divisions. More specifically, each division is provided with a mail inbox 300A illustrated in FIG. 13, which illustrates the mail inbox 300A. The delivery items 100 are each contained in the corresponding mail inbox 300A.

Like the mail outbox 200A, the mail inbox 300A is attached with a barcode (code image) 300B. The barcode 300B contains identification information that identifies the mail inbox 300A (hereinafter, referred to as “inbox identification information”).

The barcode reader 30B reads the barcode 300B attached to the mail inbox 300A and acquires the inbox identification information at the mailroom. Further, the barcode reader 30B also reads the barcode 130 attached to the delivery item 100 to be contained in the mail inbox 300A and acquires the delivery-item identification information.

The inbox identification information and the delivery-item identification information that have been acquired are sent to and registered in the server apparatus 40 in association with each other.

The server apparatus 40 associates, by using the delivery-item identification information as the key, the inbox identification information with already registered information associated with the delivery-item identification information as in the above-described case.

In the delivery management system 1 according to the exemplary embodiment, the number of delivery items 100 to be delivered to the branch B is grasped in advance by referring to the server apparatus 40. This configuration makes it possible to check whether all the delivery items 100 have arrived at the branch B by comparing the number of delivery items 100 that have actually arrived at the branch B with the number of delivery items 100 registered in the server apparatus 40 in the exemplary embodiment.

### Process Performed at Each Division of Branch B

After the delivery items 100 have been contained in the mail inbox 300A at the mailroom, the mail inbox 300A is delivered to the corresponding division. At each division, each recipient takes out the delivery item 100 addressed to the recipient from the mail inbox 300A.

Then, the recipient performs a process for receiving the delivery item 100 by using the image acquisition apparatus 10B installed at the division.

Like the sending process, an authentication process is first performed to receive the delivery item 100. Specifically, upon the recipient starting operating the image acquisition apparatus 10B, the authentication unit 204 displays a login window, namely, a window for authentication of the recipient, on the operation screen 7 as in FIG. 6. The recipient inputs his/her employee ID and password on this window.

The authentication unit 204 then compares the input set of the employee ID and the password with sets of the employee ID and the password pre-stored in the image acquisition apparatus 10B. If the input set of the employee ID and the password matches one of the sets of the employee ID and the password pre-stored in the image acquisition apparatus 10B, that is, if the authentication is successful, the authentication unit 204 switches the window displayed on the operation screen 7 to another one.

Note that the authentication process may be performed by reading an ID card prepared for each employee as described above.

After the authentication process has been finished, the login window displayed on the operation screen 7 is switched to another window (not illustrated) which includes multiple icons (images for selecting functions) as in the sending process described above. The multiple icons include the icon for delivery. Upon the recipient selecting the icon for delivery, the “Register Delivery” button 71 and the “Register Completion of Receipt” button 72 are displayed as illustrated in FIG. 7. This step is a step for receiving the delivery item 100, and thus the recipient presses the “Register Completion of Receipt” button 72.

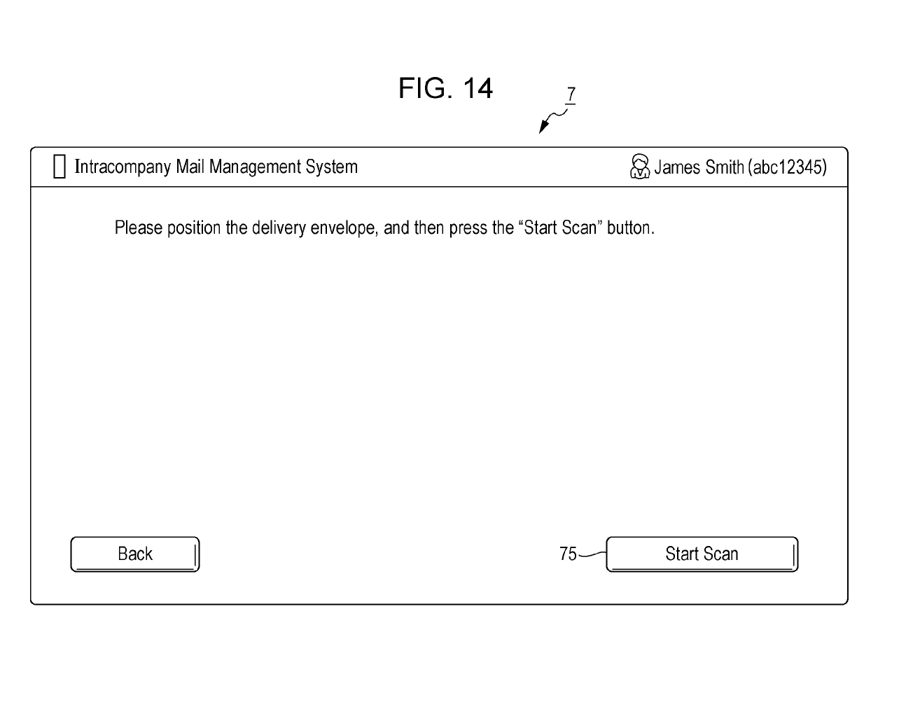

In response to pressing of the “Register Completion of Receipt” button 72, a window illustrated in FIG. 14, which illustrates an exemplary window displayed on the operation screen 7, is displayed on the operation screen 7. The recipient positions the received delivery item 100 at the image acquisition unit 6 of the image acquisition apparatus 10B and presses a “Start Scan” button 75 illustrated in FIG. 14.

In response to this action, the delivery item 100 is scanned, and consequently a delivered-item image which is an image of the delivery item 100 that has been delivered to the destination is acquired. The maximum size of an item which the image acquisition unit 6 is able to scan is larger than the size of the delivery item 100 as described above. Accordingly, an image of the entire delivery item 100 is acquired.

In the exemplary embodiment, the identification information acquisition unit 202 then analyzes an image of the barcode 130 contained in the delivered-item image and acquires delivery-item identification information contained in the barcode 130. The sending unit 203 then sends the delivered-item image and the delivery-item identification information to the server apparatus 40. In addition, in the exemplary embodiment, the date and time at which the delivered-item image has been acquired is sent to the server apparatus 40 as the received date and time of the delivery item 100.

The sending unit 203 also sends recipient information which is information regarding the recipient of the delivery item 100 to the server apparatus 40 along with the delivered-item image, the delivery-item identification information, and the received date and time.

Like the sender information, information regarding the recipient who has been authenticated by the authentication unit 204 is sent as the recipient information to the server apparatus 40.

The server apparatus 40 associates, by using the delivery-item identification information as the key, the delivered-item image, the received date and time, and the recipient information with already registered information associated with the delivery-item identification information.

There may be a case where a registration process is not performed by the recipient because the recipient has forgotten to do so in the delivery management system 1 according to the exemplary embodiment. In such a case, information indicating completion of receipt is not registered in the server apparatus 40. To avoid such a situation lasting for a long time, information indicating completion of receipt may be registered in the server apparatus 40 after a predetermined period of time has passed from arrival of the delivery item 100 at the mailroom, for example.

In addition, in the case where the registration process is not performed by the recipient, information indicating completion of receipt may be registered in the server apparatus 40 when the delivery envelope 110 that has been used for the delivery item 100 received by the recipient is used later.

Even if the registration process is not performed by the recipient, the delivery envelope 110 used for the delivery item 100 received by this recipient is sometimes used for delivery of another delivery item 100 later. In such a case, information indicating that the delivery item 100 has been received by the recipient may be registered in the server apparatus 40 when delivery of the other delivery item 100 is registered in the server apparatus 40.

The case of delivering the delivery item 100 from the branch A to the branch B which is a branch different from the branch A has been described above by way of example; however, the above-described process is applicable to delivery from the division A of the branch A to the division B of the branch A.

A process of delivering the delivery item 100 between divisions within one company has been described above by way of example; however, the above-described process according to the exemplary embodiment is also applicable to delivery of the delivery item 100 between different companies.

In addition, the above-described process according to the exemplary embodiment is also applicable to pickup of items at convenience stores and delivery of items to homes, which are widely carried out.

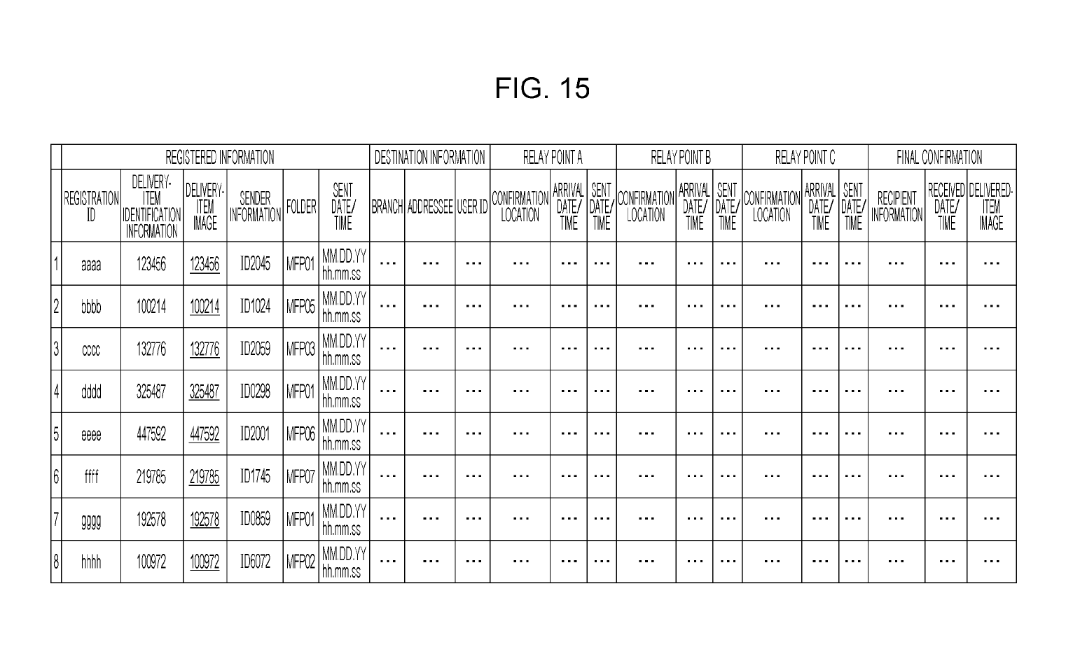

FIG. 15 illustrates a list of information sets stored in the storage unit 401 of the server apparatus 40.

As described above, in the exemplary embodiment, information is sent to and stored in the server apparatus 40 in response to each process.

The server apparatus 40 stores information such as registered information, destination information, information regarding each relay point, and information regarding final confirmation. Although not illustrated in FIG. 15, the server apparatus 40 also stores the arrival date and time of the delivery item 100 at the mailroom and the apparatus identification information that identifies each of the image acquisition apparatuses 10A and 10B in association with the delivery-item identification information.

The registered information is information generated as a result of the registration process performed by the sender. Examples of the registered information include a registration ID used to identify the registered information, delivery-item identification information, a delivery-item image, sender information, a folder name, and the sent date and time.

The destination information is information regarding the destination of the delivery item 100. Examples of the destination information include the name of the branch (including the name of the division as well as the name of the branch) and the addressee (the name of the recipient). In addition, the user ID of the recipient may be registered.

Examples of the information regarding each relay point include the location of the relay point (illustrated as “confirmation location” in FIG. 15), the arrival date and time which is the date and time at which the delivery item 100 has arrived at the relay point, and the sent date and time which is the date and time at which the delivery item 100 has been sent from the relay point. These pieces of information are registered for each relay point.

The information regarding final confirmation is information generated as a result of the registration process performed by the recipient. Examples of the information regarding final confirmation include the recipient information, the received date and time, and the delivered-item image.

### Search Process

Now, a search process for searching for information stored in the server apparatus 40 will be described.

In the exemplary embodiment, the sender is allowed to search for information by accessing the server apparatus 40 using the terminal apparatus 20A installed at the branch A or a PC owned by the sender, for example. This configuration allows the sender to grasp the delivery information (delivery status) of his/her item, for example.

In addition, an administrator is allowed to search for information by accessing the server apparatus 40 using the management terminal 50 (see FIG. 1). This configuration allows the administrator to grasp, for example, the total number of delivery items 100 processed per day and consequently obtain various statistics.

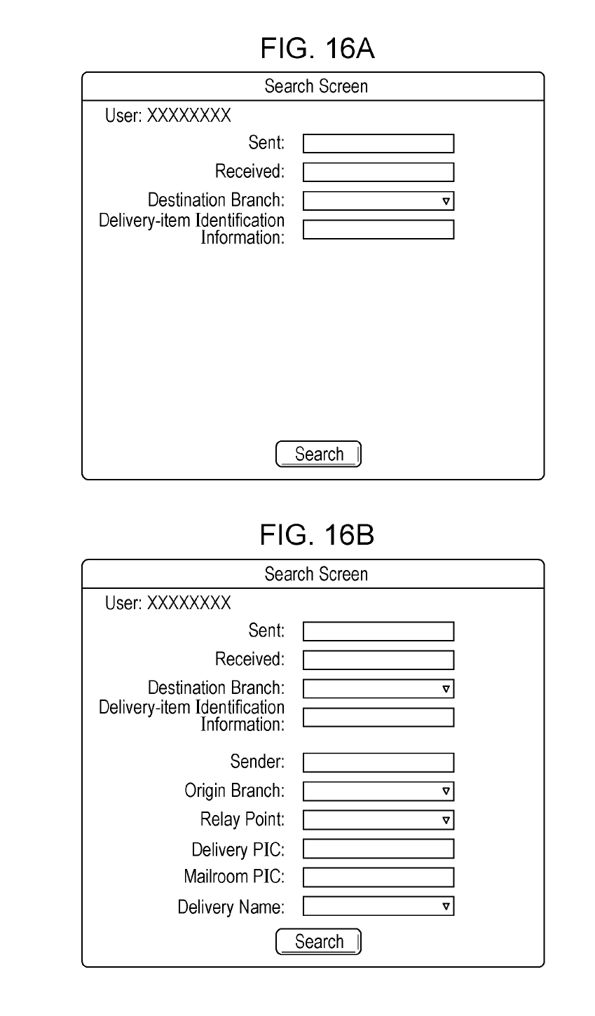

FIGS. 16A and 16B each illustrate a search window displayed at the time of a search.

FIG. 16A illustrates a search window that is displayed on the terminal apparatus 20A installed at each division of the branch A or a PC owned by the sender when the sender performs a search. FIG. 16B illustrates a search window displayed on the management terminal 50 when the administrator performs a search.

When the sender performs a search, the sender inputs, for example, the sent date and time, the received date and time, or the destination branch on the search window illustrated in FIG. 16A. Input of the delivery-item identification information is also permitted. This configuration allows the sender to check the delivery information (delivery status) of the delivery item 100 by using the delivery-item identification information.

When the administrator performs a search, the administrator inputs, for example, the sent date and time, the received date and time, the destination branch, the delivery-item identification information, the sender, the origin branch, the relay point, the person in charge for delivery (delivery PIC), the person in charge at the mailroom (mailroom PIC), or the delivery name (delivery name of a truck) on the search window illustrated in FIG. 16B.

Although a description has been omitted above, information such as a person in charge for delivery who delivers the delivery item 100, a person in charge at the mailroom who sorts the delivery items 100 at the mailroom, and the delivery name of the truck used for delivery may be registered in the server apparatus 40. In such a case, a search is performed by using such information.

The person in charge for delivery is registered in the server apparatus 40 in the following manner, for example. Identification information is read from the ID card owned by the person in charge for delivery. The identification information is then sent to the server apparatus 40. Likewise, the person in charge at the mailroom is registered in the server apparatus 40 in the following manner, for example. Identification information is read from the ID card owned by the person in charge at the mailroom. The identification information is then sent to the server apparatus 40. The delivery name of a truck is registered in the server apparatus 40 by the person in charge for delivery registering the delivery name of the truck in the server apparatus 40.

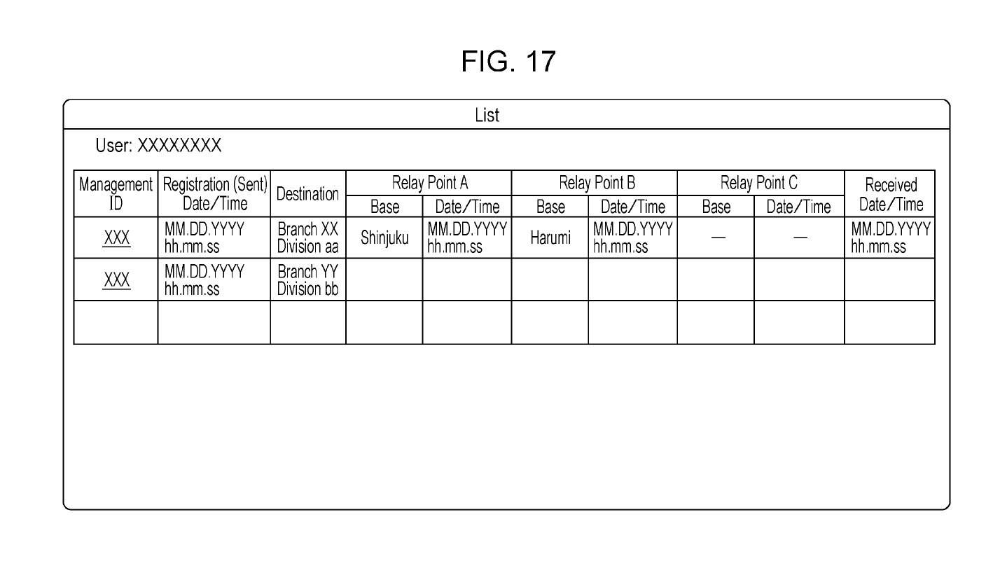

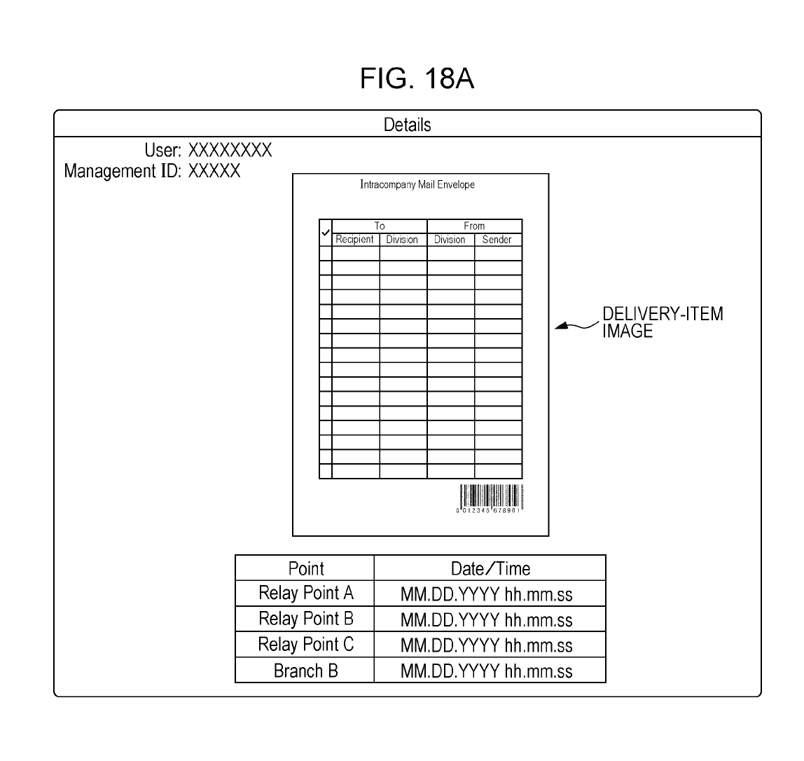

FIGS. 17 to 18B each illustrate a result of a search performed by the sender.

FIG. 17 illustrates a list of search results. The list of search results includes the management ID, the registration date and time (the sent date and time), the destination, information regarding each relay point (the base name (location) and the date and time (the arrival date and time)), and the received date and time of the delivery item 100.

In the exemplary embodiment, each management ID has a link. In response to selection of a management ID, the window is switched to a window of details illustrated in FIG. 18A or 18B. Details are displayed for each management ID (delivery-item identification information).

FIG. 18A illustrates details displayed in the case where the delivery item 100 has been delivered to the recipient. In the case where the delivery item 100 has been delivered to the recipient, the arrival date and time at the branch B as well as the date and time (the received date and time) at each relay point are displayed. In addition, the details also include the delivery-item image, which allows the sender to check the delivery-item image.

FIG. 18B illustrates details displayed during delivery of the delivery item 100. While the delivery item 100 is being delivered, the date and time (the received date and time) is displayed for some of the relay points. However, the date and time is not displayed for the relay point (the relay point C) and the branch B which the delivery item 100 has not arrived at yet. The details also include the delivery-item image.

FIGS. 18A and 18B describe the case where the delivery-item image is displayed by way of example; however, the delivered-item image may be displayed in addition to or instead of the delivery-item image.

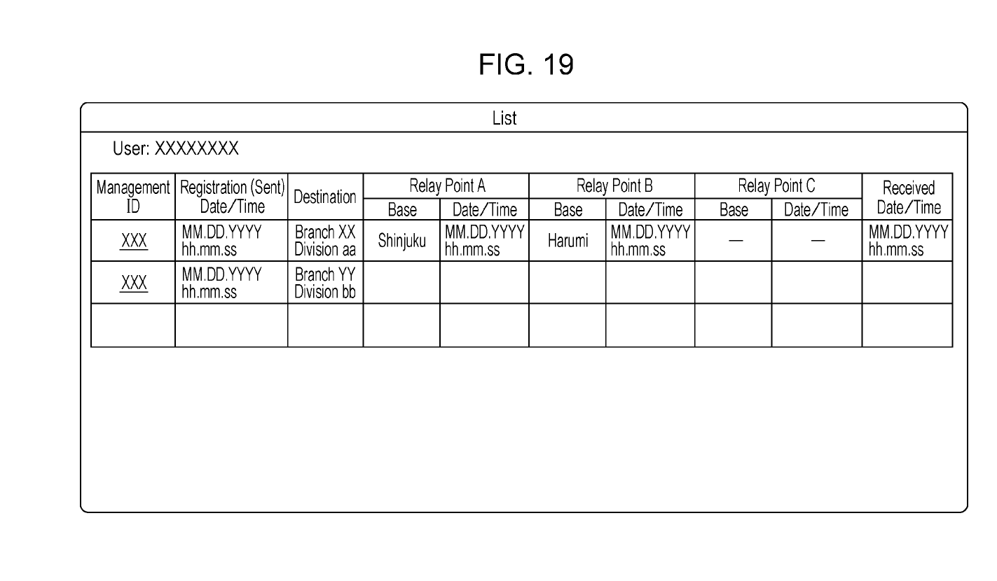

In addition, the delivered-item image may be displayed likewise in FIG. 20 (described later) or both the delivery-item image and the delivered-item image may be displayed.

In an existing delivery process currently widely carried out, the sender handwrites information such as the destination on a waybill (composed of multiple pieces of pressure-sensitive paper) and keeps a piece of the multiple pieces of pressure-sensitive paper as a copy. When the sender checks the delivery information (delivery status) of the delivery item 100, the sender inputs identification information written on the copy by using a PC or the like.

In contrast, in the exemplary embodiment, the delivery-item image is stored in the server apparatus 40. This configuration allows the sender to access information equivalent to the waybill by accessing the server apparatus 40. Accordingly, in the exemplary embodiment, the sender is no longer required to keep the copy of the waybill. In addition, in the existing delivery process, the loss of the copy of the waybill makes it difficult to check the delivery information (delivery status). In contrast, in the exemplary embodiment, the user is allowed to check the delivery information by using information such as the sent date and time (see FIG. 16A). This configuration makes it easier to check the delivery information than the existing delivery process.

In the existing delivery process, in the case where one sender sends many delivery items 100, it becomes difficult to grasp what each delivery item 100 that has been sent is like.

In contrast, in the exemplary embodiment, the sender is allowed to check the delivery-item image. This configuration allows the sender to confirm what the delivery item 100 sent by the sender is like. Further, in the case where the sender is allowed to check the delivered-item image, the configuration allows the sender to check the state of the delivery item 100 that has reached the destination.

Further, in the exemplary embodiment, an amount of information provided to the sender or the recipient is larger than that of the existing delivery process. The exemplary embodiment allows the sender or the recipient to grasp not only the delivery information (delivery status) of the delivery item 100 but also the person in charge for delivery who delivers the delivery item 100 and the delivery name of the truck by accessing the server apparatus 40. The exemplary embodiment also allows the sender or the recipient to grasp the arrival date and time and the sent date and time of the delivery item 100 at each relay point. Further, the exemplary embodiment allows the administrator to obtain the total number of delivery items 100 processed per day or various statistics.

In the exemplary embodiment, the case of registering the delivery-item image in the server apparatus 40 has been described by way of example; however, the delivery-item image may be registered in, for example, the image acquisition apparatus 10A in addition to the server apparatus 40. This configuration allows the sender to check the delivery-item image by using the image acquisition apparatus 10A. Once the image acquisition apparatus 10A acquires a delivery-item image, the image acquisition apparatus 10A may send this delivery-item image to the server apparatus 40 and to the terminal apparatus 20A installed at the corresponding division or a PC owned by the sender.

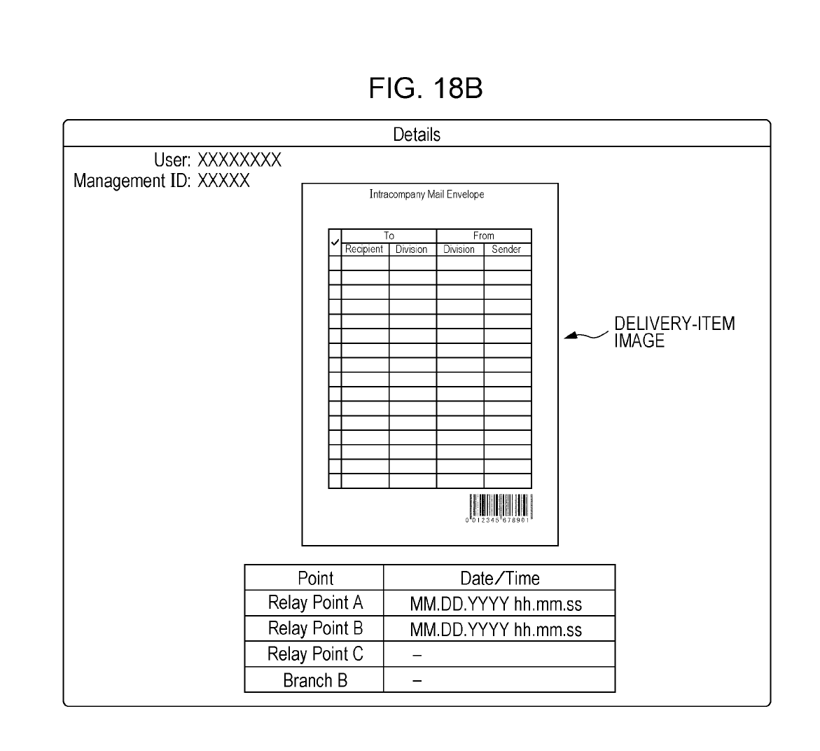

FIGS. 19 and 20 each illustrate a result of a search performed by the administrator.

FIG. 19 illustrates a list of search results. As in FIG. 17, the list of search results includes the management ID, the registration date and time (the sent date and time), the destination, information regarding each relay point (the base name (location) and the date and time (the arrival date and time)), and the received date and time of the delivery item 100.

Further, as described above, each management ID has a link. In response to selection of a management ID, the window is switched to a window of details illustrated in FIG. 20. Details are displayed for each management ID (delivery-item identification information).

FIG. 20 illustrates details displayed in the case where the delivery item 100 has been delivered to the recipient. As described above, after the delivery item 100 has been delivered to the recipient, the date and time (the arrival date and time) at each relay point and the arrival date time at the branch B are displayed. In addition, the details also include a delivery-item image.

Further, the window for the administrator also provides information such as a sender, a person in charge for delivery, a person in charge at the mailroom, and a delivery name. FIG. 20 illustrates an exemplary window displayed in the case where the delivery item 100 has been delivered to the recipient. In the case where the delivery item 100 has not been delivered to the recipient yet, the date and time is not displayed for the relay point and the branch B which the delivery item 100 has not arrived at yet, as in FIG. 18B.

### Modifications

In the exemplary embodiment described above, each delivery item 100 is identified by using the barcode 130 attached to the delivery item 100; however, each delivery item 100 may be attached with a radio frequency identification (RFID) tag and may be identified by using delivery-item identification information stored on the RFID tag. Alternatively, each delivery item 100 may be attached with both the barcode 130 and the RFID tag.

In the case of attaching the RFID tag, the delivery-item identification information is acquirable by sequentially sending the delivery items 100 to a gate equipped with a reader that reads the RFID tag. This configuration automates registration of information in the server apparatus 40.

More specifically, for example, a gate equipped with a reader that reads the RFID tag is installed at the mailroom and the relay points. The delivery items 100 are sequentially sent to the gate so as to acquire the delivery-item identification information. This configuration achieves an increased efficiency in acquiring the delivery-item identification information.

In addition, each delivery item 100 may be assigned information concerning paper fingerprint. Specifically, the state (the pattern of paper fibers) of the surface of the delivery envelope 110 is encoded into paper fingerprint information, and the resulting paper fingerprint information may be contained in the barcode 130 or stored in the RFID tag.

Such a configuration, for example, allows the recipient to detect a mix-up between the delivery item 100 and another one. When the delivery item 100 is mixed up, the paper fingerprint information contained in the barcode 130 does match paper fingerprint information obtained from the delivery envelope 110 received by the recipient.

The case where the image acquisition apparatus 10A or 10B analyzes the barcode 130 attached to the delivery item 100 (acquires the delivery-item identification information) has been described above by way of example; however, the delivery-item image and the delivered-item image may be sent to the server apparatus 40 and the server apparatus 40 may analyze the delivery-item image and the delivered-item image to acquire the delivery-item identification information.

In the image acquisition apparatus 10A, the delivery-item information acquisition unit 103 may acquire information assigned to the delivery item 100 (delivery-item information). Specifically, the delivery-item information acquisition unit 103 may analyze the delivery-item image by using an optical character recognition (OCR) function or the like and acquire information assigned to the delivery item 100. The term “delivery-item information” refers to information relating to the delivery item 100, such as information indicating the properties and condition of the delivery item 100.

This configuration enables, for example, acquisition of information (e.g., the destination information) assigned to the delivery item 100 by handwriting. That is, in this case, the delivery-item image is an image of text written on the package of the delivery item 100 and contains information that uniquely identifies the destination or the origin. In this case, the delivery-item image is analyzed by using the OCR function or the like, and the information that uniquely identifies the destination or the origin is acquired.

In the case of analyzing the delivery-item image by using the OCR function or the like as in the exemplary embodiment, a process may be performed such that the delivery management system 1 is applied to intracompany mails and is not applied when the delivery item 100 is sent to outside the company even from the same origin, for example. Specifically, for example, a process may be performed such that the delivery management system 1 is not applied to the delivery item 100 in the case where the delivery-item image of the delivery item 100 includes an image of a zip code or a store number.

In addition, in the case where the delivery item 100 is attached with an instruction for express delivery or the like, the delivery-item information acquisition unit 103 enables acquisition of the instruction for express delivery. Also, in the case where the delivery envelope 110 has text such as “Confidential Personnel” written thereon, which indicates that the delivery envelope 110 contains an intracompany personnel document, the delivery-item information acquisition unit 103 enables acquisition of the information indicating “Confidential Personnel”.

Note that the information assigned to the delivery item 100 is not necessarily acquired by the image acquisition apparatus 10A. The delivery-item image may be sent to the server apparatus 40, and the server apparatus 40 may acquire the information.

The information acquired by the delivery-item information acquisition unit 103 may be displayed on the operation screen 7 of the image acquisition apparatus 10A, and a correction to this information may be accepted from the sender through the operation screen 7. This configuration allows correct information to be registered in the server apparatus 40.

In the exemplary embodiment, a delivery route of the delivery item 100 is registered in advance. This configuration enables detection of the delivery mistake of the delivery item 100. Specifically, the delivery mistake of the delivery item 100 is detected by comparing (verifying) the relay point which the delivery item 100 has arrived at with the relay point registered in advance.

In addition, the delivery management system 1 according to the exemplary embodiment may further include a setting unit that pre-sets an origin candidate and a destination candidate, and the delivery management system 1 may be applied to an origin and a destination that are pre-set by the setting unit.

Specifically, for example, the image acquisition apparatuses 10A and 10B may be registered in advance, and a process may be performed such that images from unregistered image acquisition apparatuses are not stored in the server apparatus 40. In addition, a process may be performed such that the delivery-item image is not stored in the server apparatus 40 in the case where the corresponding delivery-item identification information is not registered in advance. Further, for example, in the case of delivering the delivery item 100 from a predetermined origin to a destination that is not predetermined, a process for prompting registration of the destination as a new destination may be performed through the operation screen 7 of the image acquisition apparatus 10A or 10B. In this case, the origin may be notified that delivery is not managed by the delivery management system 1.

In response to a registration process performed by the recipient, information indicating that the recipient has received the delivery item 100 may be sent to the sender. Specifically, information indicating that the recipient has received the delivery item 100 is sent from the server apparatus 40 to the terminal apparatus 20A installed at the corresponding division or a PC owned by the sender, for example.

In addition to the timing at which the recipient has received the delivery item 100, the sender may be notified that the delivery item 100 has arrived at the relay point each time the delivery item 100 has arrived at each of the relay points A, B, and C. That is, the delivery information (delivery status) may be sent to the sender at every suitable timing.

The sender information which is information regarding the sender is not limited to the name of the sender and may be the name of the division where the image acquisition apparatus 10A is installed. That is, the name of the division where the image acquisition apparatus 10A is installed may be registered as the sender information in the server apparatus 40.

For example, the entire delivery-item identification information on the delivery envelope 110 may be registered in the server apparatus 40 before operation of the delivery management system 1 is started. With this configuration, it is determined whether the delivery envelope 110 that is about to be used by the sender is usable.

Specifically, the delivery-item identification information acquired by the image acquisition apparatus 10A is compared with the delivery-item identification information pre-registered in the server apparatus 40. In this way, it is determined whether the delivery envelope 110 that is about to be used by the sender is usable.

If the delivery-item identification information is not registered in the server apparatus 40, the sender is notified that “This delivery envelope 110 is not usable”, for example. For example, there may be a case where the sender creates the delivery envelope 110. In such a case, the delivery-item identification information is not registered in the server apparatus 40. Accordingly, the sender is notified that “This delivery envelope 110 is not usable”.

Alternatively, in the case where the delivery-item identification information assigned to the delivery envelope 110 is not registered in the server apparatus 40 as a result of the user creating the delivery envelope 110, the delivery-item identification information may be registered in the server apparatus 40 so as to make the delivery envelope 110 usable.

There may be a case where the delivery envelopes 110 prepared at the origin are not enough. In such a case, the check field 111, the destination field 112, the origin field 113, and the barcode 130 illustrated in FIG. 5 may be printed on an envelope (plain envelope) by using the image forming unit 5 (see FIG. 1) of the image acquisition apparatus 10A installed at the origin, for example.

Note that the delivery-item identification information used in this case (the delivery-item identification information contained in the barcode 130) is selected by the server apparatus 40 from among unused pieces of delivery-item identification information and is sent to the image acquisition apparatus 10A, for example. The image acquisition apparatus 10A generates the barcode 130 containing this unused delivery-item identification information and prints the barcode 130 on the envelope.

Note that medium used for printing is not limited to an envelope. The barcode 130 may be printed on paper, and the paper may be adhered to the delivery envelope 110.

Multiple kinds of delivery envelopes 110 may be prepared, and different processes may be performed depending on the delivery envelopes 110. For example, there may be a case where the division is prioritized as the destination of the delivery item 100 and a case where the person is prioritized as the destination of the delivery item 100. In the case of prioritizing the division, a certain kind of envelope is used. In the case of prioritizing the person, another kind of envelope is used.

Specifically, in the exemplary embodiment, the name of the division and the name of the recipient are written on the delivery envelope 110; however, the sender sometimes wishes to send the delivery item 100 to a division (organization) rather than a specific recipient.

In such a case, the delivery envelope 110 for receipt by a person and the delivery envelope 110 for receipt by a division are prepared, and the delivery envelope 110 used is changed depending on the desired recipient.

In this case, information indicating whether a person is prioritized or a division is prioritized is included in the information contained in the barcode 130 attached to the delivery envelope 110. This configuration allows information indicating that “a person is prioritized” or “a division is prioritized” to be registered in the server apparatus 40 and allows a prioritized entity to be gasped by referring to the server apparatus 40.

Likewise, envelopes used at urgent times and envelopes according to the confidential level may be prepared. In this case, information indicating the urgency level and information indicating the confidential level are included in information contained in the barcode 130. This configuration allows these pieces of information to be also registered in the server apparatus 40 and allows the urgency level of delivery of the delivery item 100 and the confidential level of the delivery item 100 to be grasped by referring to the server apparatus 40.

### Other Exemplary Configurations

The delivery management system 1 may be used for in-house round robin decision making, for example. When round robin decision making is performed, a written request for decision regarding a matter to be decided is created, and the written request for decision is circulated to multiple divisions. A person with authority at each division then makes a decision (for approval or rejection).

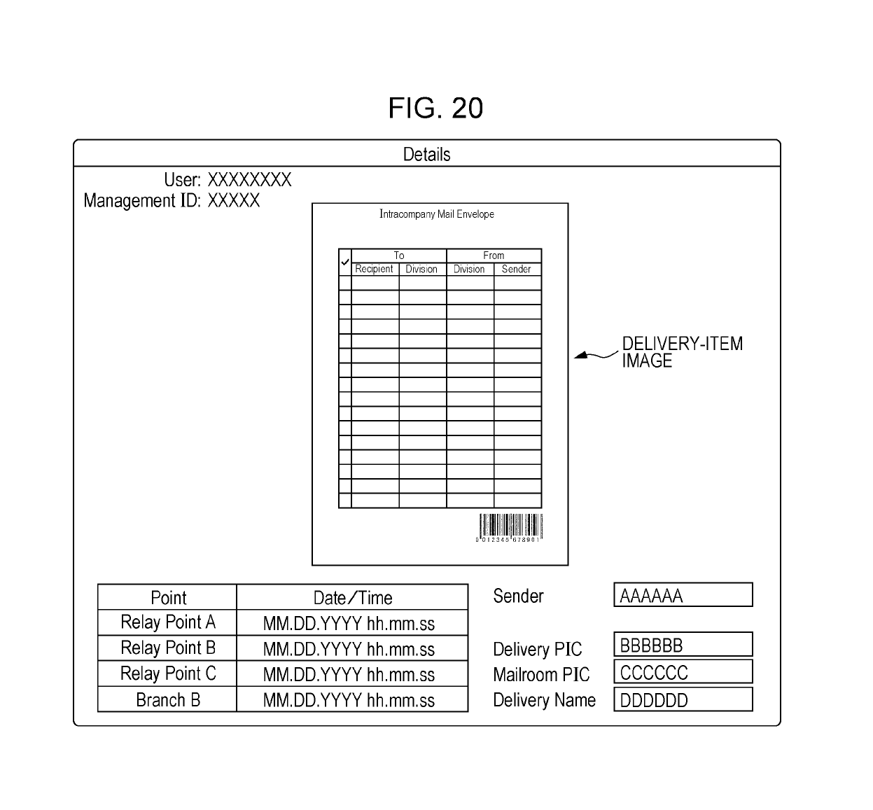

FIG. 21 illustrates an exemplary configuration of the delivery management system 1 according to the exemplary embodiment applied to in-house round robin decision making.

The delivery management system 1 illustrated in FIG. 21 includes an accepting division 501 that accepts a written request for decision (delivery item) 150. From this accepting division 501, the written request for decision 150 is circulated to individual divisions (this example illustrates four divisions 502, 503, 504, and 505). The written request for decision 150 that has been circulated returns to the accepting division 501.

In this delivery management system 1, the accepting division 501 is provided with an image acquisition apparatus 10R and a terminal apparatus 20R, such as a PC. Further, the divisions 502, 503, 504, and 505 are each provided with an image acquisition apparatus 10T and a terminal apparatus 20T. Further, the delivery management system 1 includes the server apparatus 40 connected to the image acquisition apparatuses 10R and 10T and the terminal apparatuses 20R and 20T.

Before the written request for decision 150 is circulated, the accepting division 501 attaches the barcode 130 to the written request for decision 150. The barcode 130 contains identification information (delivery-item identification information) that identifies the written request for decision 150. Then, at the accepting division 501, an image of the written request for decision 150 (delivery-item image) is acquired by using the image acquisition apparatus 10R. Then, the delivery-item image and the delivery-item identification information acquired from the barcode 130 are registered in the server apparatus 40 as in the above-described case.

The written request for decision 150 is then circulated to the divisions 502, 503, 504, and 505.

At each of the divisions 502, 503, 504, and 505, a receiving process and a sending process are performed for the written request for decision 150.

Specifically, upon arrival of the written request for decision 150 at each of the divisions 502, 503, 504, and 505, a recipient who has received the written request for decision 150 registers completion of receipt as described with reference to FIG. 7, for example. Specifically, after performing an authentication process, the recipient positions the written request for decision 150 at the image acquisition apparatus 10T and performs a scan. In response to this operation, the arrival date and time of the written request for decision 150 and an image of the written request for decision 150 (delivered-item image) are registered in the server apparatus 40.

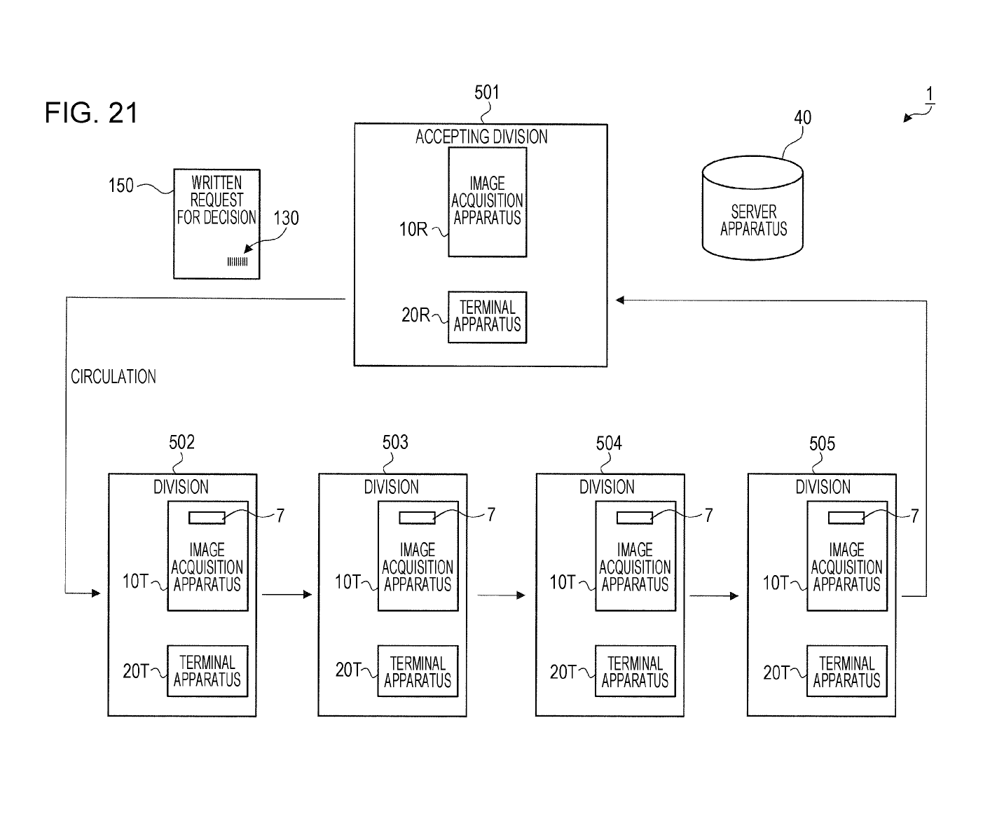

The image acquisition apparatus 10T displays a window for accepting a response to the written request for decision 150 from a person with authority, who is a respondent, on the operation screen 7 as illustrated in FIG. 22, which illustrates an exemplary window displayed on the operation screen 7. The person with authority performs an operation on the operation screen 7 to input a response to the written request for decision 150.

Specifically, the person with authority presses “Approve” if the person approves the request for decision. The person with authority presses “Reject” if the person rejects the request for decision. The input response is sent to and registered in the server apparatus 40.

Specifically, the image acquisition apparatus 10T includes a response accepting unit that accepts, from a respondent, a response to an inquiry contained in the written request for decision 150 serving as a delivery item.

In the exemplary embodiment, the response accepting unit obtains a response from a person with authority and sends the response to the server apparatus 40. The response accepting unit is realized by the CPU controlled by a program and the operation screen 7.

A response is accepted by accepting an operation performed by a person with authority on the operation screen 7; however, the person with authority may write a response on the written request for decision 150. In such a case, an image of the written request for decision 150 which is acquired by the image acquisition apparatus 10T may be analyzed by using, for example, the OCR function, and a response from the person with authority may be acquired. Note that the analysis may be performed by the image acquisition apparatus 10T or the server apparatus 40.

Subsequently, a sending process is performed.

In the sending process, an authentication process is performed first as in the above-described case. Then, the sender positions the written request for decision 150 at the image acquisition apparatus 10T to acquire an image of the written request for decision 150 (delivery-item image). The sender information, the sent date and time of the written request for decision 150, and the image of the written request for decision 150 (delivery-item image) are sent from the image acquisition apparatus 10T to the server apparatus 40 and are registered in the server apparatus 40.

The written request for decision 150 is then sent to the next division. The receiving process and the sending process are performed similarly at the next division.

After the written request for decision 150 has returned to the accepting division 501, the receiving process is performed at the accepting division 501. In this receiving process, after performing the authentication process, the recipient positions the written request for decision 150 at the image acquisition apparatus 10R and scans the written request for decision 150 as in the above-described case. In response to this operation, the arrival date and time of the written request for decision 150 and an image of the written request for decision 150 (delivered-item image) are registered in the server apparatus 40.

The processes according to the exemplary embodiment allow the circulation status of the written request for decision 150 to be grasped with reference to the server apparatus 40. In addition, in the exemplary embodiment, a response to the written request for decision 150 is accepted on the operation screen 7 of each image acquisition apparatus 10T and the responses are accumulated in the server apparatus 40. Accordingly, an operation for manually counting the responses at the accepting division 501 is omitted.

Electronic data of the written request for decision 150 may be sent to persons with authority at the respective divisions 502, 503, 504, and 505, for example, by email before the written request for decision 150 is circulated to the individual divisions 502, 503, 504, and 505. In this case, the persons with authority are allowed to check the content of the written request for decision 150 before the written request for decision 150 is circulated to them. In such a case, a decision regarding approval or rejection is made speedily at each division.

### Display on Operation Screen

As described above, in the exemplary embodiment, multiple icons are displayed on the operation screen 7. When the delivery item 100 or the written request for decision 150 is sent or received, the icon for delivery is selected.

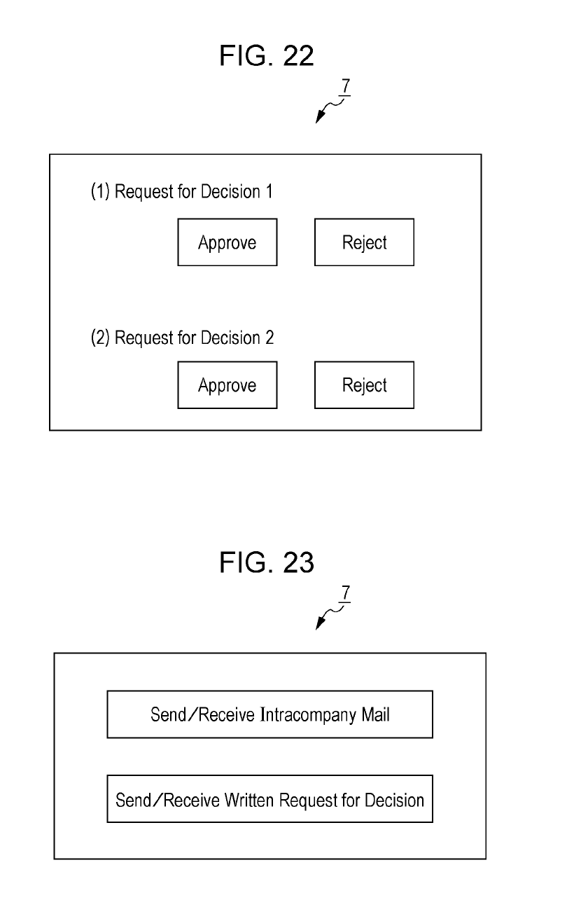

In response to selection of the icon for delivery, the image acquisition apparatus 10T installed at each of the divisions 502, 503, 504, and 505 to which the written request for decision 150 is circulated may display two buttons, namely, a “Send/Receive Intracompany Mail” button and a “Send/Receive Written Request for Decision” button, as illustrated in FIG. 23, which illustrates an exemplary window displayed on the operation screen 7, for example.

A person who sends or receives the delivery item 100 presses the “Send/Receive Intracompany Mail” button. A person who sends or receives the written request for decision 150 presses the “Send/Receive Written Request for Decision” button.

Display of an icon involving the written request for decision 150, such as the “Send/Receive Written Request for Decision” button, may be omitted initially. The icon involving the written request for decision 150 may be displayed when it is determined that the delivery item 100 is the written request for decision 150 as a result of analysis of the delivery-item image acquired by scanning the delivery item 100.

### Ways of Providing Program

A program executed by each image acquisition apparatus or the server apparatus 40 is provided to the image acquisition apparatus or the server apparatus 40 such that the program is pre-stored in a ROM included in the image acquisition apparatus or the server apparatus 40, and the program is loaded into a RAM. If the image acquisition apparatus or the server apparatus 40 includes a rewritable ROM, such as an electrically erasable programmable ROM (EEPROM), the program alone is installed in the ROM after the CPU has been set, and the program is loaded into the RAM. Alternatively, the program is transmitted via a network such as the Internet, is installed in the ROM, and is loaded into the RAM. The program is provided to the image acquisition apparatus or the server apparatus 40 via an external recording medium, such as a digital versatile disc ROM (DVD-ROM) or a flash memory.

There may be provided an accepting unit, a scanning unit, and a determining unit. The accepting unit accepts a request for a process relating to management of delivery. The scanning unit scans a text image and a code that are attached to a delivery item, the code identifying the delivery item. The determining unit determines whether an image obtained by scanning includes a code corresponding to the process. The control may be performed such that, in the case where it is determined that the image obtained by scanning includes a code corresponding to the process, a process for registering the code and the text image in a database of delivery items to be delivered, a process for updating the database in order to issue a notification indicating that the delivery item has been delivered, and a process for registering a code are performed. For example, an image forming apparatus may include the accepting unit, the scanning unit, and the determining unit. Information may be sent from the image forming apparatus to a server that performs the processes.

The image forming apparatus may further include a first display unit, a second display unit, and a controller. The first display unit displays, on a display, a first menu window including a menu for invoking a delivery management function of the image forming apparatus with a single touch. The second display unit displays, on the display, a second menu window including a menu for invoking a function other than the delivery management function with a single touch. The controller performs control to determine which is to be preferentially displayed, the first menu window or the second menu window.

For example, the image forming apparatus is incorporated into the delivery management system; however, it is preferable to display the second menu window if the image forming apparatus is often used for copying and printing, whereas it is preferable to display the first menu window if the image forming apparatus is often used for management of delivery.

The image forming apparatus may further include an acquisition unit and a generation unit. The acquisition unit acquires information indicating either identification information that identifies a delivery item or warning information indicating an importance or urgency level of a delivery item. The generation unit generates information representing an image including fields in which the acquired information and a destination are to be written. The image forming apparatus may be controlled to form an image on a medium so that the generated information is created on the medium.

Specifically, for example, in the case where a destination field on the delivery item is used up, the image forming apparatus including the scanning unit that usually scans a code and an image forming unit may be assigned a new code and may be notified of the assigned code by a server.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A delivery management system comprising:
a first image acquisition unit that acquires, at an origin, an image of a delivery item to be delivered to a destination;
a delivery information acquisition unit that acquires delivery information regarding the delivery item;
an identification information acquisition unit that acquires identification information that identifies the delivery item; and
a memory that stores the image of the delivery item, the delivery information regarding the delivery item, and the identification information of the delivery item in association with one another.

2. The delivery management system according to claim 1, further comprising
a second image acquisition unit that acquires, at the destination, an image of the delivery item that has been delivered to the destination, wherein
the memory stores the image of the delivery item acquired at the origin, the image of the delivery item acquired at the destination, the delivery information regarding the delivery item, and the identification information of the delivery item in association with one another.

3. The delivery management system according to claim 1, wherein the image of the delivery item is an image of text written on a package of the delivery item and contains information that uniquely identifies the origin or the destination.

4. The delivery management system according to claim 1, further comprising
a setting unit that presets an origin candidate and a destination candidate, wherein
the delivery management system is applied to an origin and a destination that are preset by the setting unit.

5. The delivery management system according to claim 1, wherein
the delivery item is attached with a code image containing the identification information,
the first image acquisition unit acquires the image of the delivery item and the code image, and
the identification information acquisition unit analyzes the code image acquired by the first image acquisition unit and acquires the identification information.

6. The delivery management system according to claim 1, wherein
the memory further stores sender information which is information regarding a sender of the delivery item,
the delivery management system further comprises an authentication unit that performs authentication of the sender, and
information regarding the sender who has been authenticated by the authentication unit is stored as the sender information in the memory.

7. The delivery management system according to claim 6, wherein the authentication unit and the first image acquisition unit are included in a multifunction image forming apparatus.

8. The delivery management system according to claim 1, further comprising
a delivery-item information acquisition unit that analyzes the image of the delivery item acquired by the first image acquisition unit and acquires information assigned to the delivery item.

9. The delivery management system according to claim 1, wherein the first image acquisition unit includes an input screen operated by a sender of the delivery item, and the input screen allows the sender to input the destination to which the delivery item is to be delivered.

10. An image forming apparatus comprising:
a scanning unit that scans a document; and
a sending unit that sends an image obtained by scanning to a specified medium, wherein
the scanning unit scans a delivery item to be delivered to a destination and obtains an image of the delivery item and identification information that identifies the delivery item, and
the sending unit sends both the image and the identification information to a medium viewable at an origin or a medium that manages a delivery status.

11. An image acquisition apparatus comprising:
an image acquisition unit that acquires an image of a delivery item to be delivered to a destination; and
a sending unit that sends the image of the delivery item acquired by the image acquisition unit to a memory which stores an image of a delivery item, delivery information regarding the delivery item, and identification information that identifies the delivery item in association with one another.

12. The image acquisition apparatus according to claim 11, wherein
the delivery item is attached with a code image containing the identification information,
the image acquisition unit acquires the image of the delivery item and the code image, and
the image acquisition apparatus further comprises an identification information acquisition unit that analyzes the code image acquired by the image acquisition unit and acquires the identification information.

13. The image acquisition apparatus according to claim 11, wherein
the sending unit further sends, to the memory, sender information which is information regarding a sender who sends the delivery item,
the image acquisition apparatus further comprises an authentication unit that performs authentication of the sender, and
the sending unit sends information regarding the sender who has been authenticated by the authentication unit as the sender information.

14. The image acquisition apparatus according to claim 11, further comprising
a delivery-item information acquisition unit that analyzes the image of the delivery item acquired by the image acquisition unit and acquires information assigned to the delivery item.

15. The image acquisition apparatus according to claim 11, further comprising
an input screen operated by a sender of the delivery item, wherein
the input screen displays a window for accepting, from the sender, the destination to which the delivery item is to be delivered.

16. An image acquisition apparatus comprising:
an image acquisition unit that acquires an image of a delivery item that has been delivered to a destination; and
a sending unit that sends the image of the delivery item acquired by the image acquisition unit to a memory storing an image of the delivery item acquired before the delivery item is sent to the destination, delivery information regarding the delivery item, and identification information that identifies the delivery item in association with one another.

17. The image acquisition apparatus according to claim 16, wherein
the sending unit further sends, to the memory, recipient information which is information regarding a recipient who has received the delivery item,
the image acquisition apparatus further comprises an authentication unit that performs authentication of the recipient, and
the sending unit sends information regarding the recipient who has been authenticated by the authentication unit as the recipient information.

18. The image acquisition apparatus according to claim 16, further comprising
a response accepting unit that accepts, from a respondent, a response to an inquiry written in the delivery item.

19. A delivery management apparatus comprising:
a receiving unit that receives an image of a delivery item to be delivered to a destination, delivery information regarding the delivery item, and identification information that identifies the delivery item, the image of the delivery item being acquired at an origin; and
a memory that stores, in association with one another, the image of the delivery item, the delivery information regarding the delivery item, and the identification information of the delivery item received by the receiving unit.

20. The delivery management apparatus according to claim 19, wherein
the receiving unit further receives an image of the delivery item acquired at the destination after the delivery item has been delivered to the destination, and
the memory stores the image of the delivery item acquired at the origin, the image of the delivery item acquired at the destination, the delivery information regarding the delivery item, and the identification information of the delivery item in association with one another.

21. A non-transitory computer readable medium storing a program causing a computer to execute a process, the process comprising:
receiving an image of a delivery item to be delivered to a destination, delivery information regarding the delivery item, and identification information that identifies the delivery item; and
storing in a memory, in association with one another, the image of the delivery item, the delivery information regarding the delivery item, and the identification information of the delivery item that have been received.

22. A non-transitory computer readable medium storing a program causing a computer to execute a process, the process comprising:
acquiring an image of a delivery item to be delivered to a destination; and
sending the acquired image of the delivery item to a memory which stores an image of a delivery item, delivery information regarding the delivery item, and identification information that identifies the delivery item in association with one another.

23. A non-transitory computer readable medium storing a program causing a computer to execute a process, the process comprising:
acquiring an image of a delivery item that has been delivered to a destination; and
sending the acquired image of the delivery item to a memory storing an image of the delivery item acquired before the delivery item is sent to the destination, delivery information regarding the delivery item, and identification information that identifies the delivery item in association with one another.

24. A delivery management method comprising:
acquiring an image of a delivery item to be delivered to a destination;
acquiring delivery information regarding the delivery item;
acquiring identification information that identifies the delivery item; and
storing the image of the delivery item, the delivery information regarding the delivery item, and the identification information of the delivery item in a memory in association with one another.
